(19) United States
(12) Patent Application Publication
(10) Pub. No.: US 2026/0352406 A1
(43) Pub. Date: Nov. 5, 2026

(54) Handling Co-Scheduled Demodulation Reference Signals in a Communication Network

(71) Applicant: Telefonaktiebolaget LM Ericsson (publ), Stockholm (SE)

(72) Inventors: Jianwei Zhang, Solna (SE); Andreas Nilsson, Göteborg (SE)

(21) Appl. No.: 19/102,911

(22) PCT Filed: Aug. 10, 2023
(86) PCT No.: PCT/EP2023/072168

§ 371 Date: Feb. 11, 2025

Related U.S. Application Data
(60) Provisional application No. 63/397,767, filed on Aug. 12, 2022.

(51) Int. Cl. H04L 5/00

(52) U.S. Cl. CPC H04L 5/0051; H04L 5/0016

(57) ABSTRACT

A method performed by a communication device (12-1, 12-2) configured for use in a communication network (10) is disclosed. The communication device (12-1) transmits, to a network node (18) in the communication network (10), signaling (22) that indicates a demodulation reference signal, DMRS, capability (24) of the communication device (12-1). In some embodiments, the DMRS capability (24) includes support for the communication network (10) co-scheduling DMRSs of different types for different communication devices (12-1, 12-2). The communication device (12-1) also receives a DMRS and/or a data channel for the communication device (12-1) from the network node (18).

### TECHNICAL FIELD

The present application relates generally to a communication network, and relates more particularly to handling of co-scheduled demodulation reference signals in a communication network.

### BACKGROUND

New Radio (NR) uses CP-OFDM (Cyclic Prefix Orthogonal Frequency Division Multiplexing) in both downlink (i.e., from a network node, gNB, or base station, to a user equipment or UE) and uplink (i.e., from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically on a slot basis where the first two symbols contain a physical downlink control channel (PDCCH) and the rest contain physical shared data channels, either PDSCH (physical downlink shared channel) or PUSCH (physical uplink shared channel). An example of the NR time-domain structure is shown in FIG. 2 with 15 kHz subcarrier spacing.

Different subcarrier spacing values are supported in NR. The supported subcarrier spacing values (also referred to as different numerologies) are given by Δf=(15×2^{μ})kHz where μ ∈0,1,2,3,4·Δf=15 kHz is the basic subcarrier spacing. The slot durations at different subcarrier spacings are given by

$$\frac{1}{{2}^{μ}} m s .$$

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 3, where only one resource block (RB) within a 14-symbol slot is shown. One OFDM subcarrier during one OFDM symbol interval forms one resource element (RE).

Downlink (DL) PDSCH transmissions can be either dynamically scheduled or semi-persistently scheduled (SPS). For dynamically scheduled DL PDSCH transmissions, in each slot the gNB transmits downlink control information (DCI) over PDCCH (Physical Downlink Control Channel) about which UE data is to be transmitted to and which RBs in the current downlink slot the data is transmitted on. For SPS DL PDSCH transmissions, periodic PDSCH transmissions are activated or deactivated by a DCI. Different DCI formats are defined in NR for DL PDSCH scheduling including DCI format 1_0, DCI format 1_1, and DCI format 1_2.

Similarly, uplink (UL) PUSCH transmission can also be scheduled either dynamically or semi-persistently with uplink grants carried in PDCCH. NR supports two types of semi-persistent uplink transmission, i.e., type 1 configured grant (CG) and type 2 configured grant. Type 1 configured grant is configured and activated by Radio Resource Control (RRC). Type 2 configured grant is configured by Radio Resource Control (RRC) but activated/deactivated by DCI. The DCI formats for scheduling PUSCH include DCI format 0_0, DCI format 0_1, and DCI format 0_2.

Demodulation reference signals (DM-RS or DMRS) are used for coherent demodulation of physical layer data channels, e.g., Physical Downlink Shared Channel (PDSCH) and Physical Uplink Shared Channel (PUSCH), as well as of physical layer control channels such as a Physical Downlink Control Channel (PDCCH). The DM-RS is confined to resource blocks carrying the associated physical layer channel and is mapped on allocated resource elements of the time-frequency resource grid such that the receiver can efficiently handle time/frequency-selective fading radio channels.

The mapping of DM-RS to resource elements is configurable in both frequency and time domain. There are two mapping types in the frequency domain, i.e., type 1 and type 2. In addition, there are two mapping types in the time domain, i.e., mapping type A and type B, which defines the symbol position of the first Orthogonal Frequency Division Multiplexing (OFDM) symbol containing DM-RS within a transmission interval.

The DM-RS mapping in time domain can further be single-symbol based or double-symbol based, where the latter means that DM-RS is mapped in pairs of two adjacent OFDM symbols. For single symbol based DMRS, a user equipment (UE) can be configured with one, two, three, or four single-symbol DM-RS (also referred to as additional DM-RS) in a time slot. For double-symbol based DMRS, a UE can be configured with one or two such double-symbol DM-RS in a time slot. In scenarios with low Doppler, it may be sufficient to configure front-loaded DM-RS only, i.e., one single-symbol DM-RS or one double-symbol DM-RS, whereas in scenarios with high Doppler additional DM-RS will be required in a slot.

FIGS. 4A-4B show an example of type 1 and type 2 front-loaded DM-RS with single-symbol and double-symbol DM-RS and time domain mapping type A with first DM-RS in the third OFDM symbol of a transmission interval of 14 symbols. Observe from FIGS. 4A-4B that type 1 and type 2 differ with respect to both the mapping structure and the number of supported DM-RS code division multiplexing (CDM) groups, where type 1 support 2 CDM groups and Type 2 support 3 CDM groups.

A DM-RS antenna port is mapped to the resource elements within one CDM group only. For single-symbol DM-RS, two antenna ports can be mapped to each CDM group, whereas for double-symbol DM-RS four antenna ports can be mapped to each CDM group. Hence, for DM-RS type 1 the maximum number of DM-RS ports is four for a single-symbol based DMRS configuration and eight for double-symbol based DMRS configuration. For DM-RS type 2, the maximum number of DM-RS ports is six for a single-symbol based DMRS configuration and twelve for double-symbol based DMRS configuration.

An orthogonal cover code (OCC) of length 2 (i.e., [+1, +1] or [+1,−1]) is used to separate antenna ports mapped in the same two resource elements within a CDM group. The OCC is applied in the frequency domain (FD) as well as in the time domain (TD) when double-symbol DM-RS is configured. This is illustrated in FIGS. 4A-4B for CDM group 0.

For antenna port tables defined for each DMRS type, some of the indices are specified to be used only for Single User (SU) Multiple Input Multiple Output (MIMO). For the remaining indices that can be used for Multi-User (MU) MIMO, whereby multiple UEs are co-scheduled at the same time/frequency resource, the UE assumes the co-scheduled UE are scheduled with the same DMRS-type and the same number of DMRS symbols.

In New Radio (NR) rel-18, the number of orthogonal demodulation reference signal (DMRS) (antenna) ports will be extended from 8 to 16 for type-1 DMRS and from 12 to 24 for type-2 DMRS. The frequency domain (FD) orthogonal cover code (OCC) length may be increased from 2 to 4 or 6, or the number of code division multiplexing (CDM) groups may be doubled.

One motivation for increasing the number of orthogonal ports is to increase the number of co-scheduled MU-MIMO UEs without increasing the DMRS overhead. However, one issue with extending the number of DMRS ports is that the SU-MIMO performance for the new DMRS design would be worse compared to legacy DMRS design. For example, when increasing the number of CDM groups, the DMRS density becomes sparser, which means that the SU-MIMO performance will be reduced compared to using legacy DMRS design due to longer OCC sequences in the frequency domain which increases the sensitivity for delay spread in the channel. In a similar way, increasing the FD-OCC length would also cause longer OCC sequences in the frequency domain and increases the sensitivity for delay spread in the channel.

Hence, different DMRS designs may be preferred for different use-case. For example, one DMRS design might be preferred for UEs scheduled with MU-MIMO (when increase of DMRS capacity is needed) and another DMRS design might be preferred for UEs scheduled for SU-MIMO or MU-MIMO but when there is a smaller DMRS capacity need.

Challenges exist therefore in realizing DMRS in rel-18, especially in a way that enables improved data channel performance and/or simplified receiver design.

### SUMMARY

In may be an object of the present invention to provide measures which enable an improved data channel performance and/or simplified receiver design.

Some embodiments herein advantageously provide a framework and/or signaling to indicate the DMRS design for co-scheduled UEs, e.g., for 5G advanced and/or 6G. In doing so, some embodiments provide improved PDSCH performance since a UE can adapt its receiver algorithms according to the indicated co-scheduled PDSCH DMRS type, and/or a UE can simplify its UE receiver design based on knowledge that co-scheduled UEs will have a certain DMRS design. Alternatively or additionally, since rate matching and DMRS power boost may depend on the number of sub-carriers used for DMRS and data, some embodiments enable the UE to determine the correct power offset between DRMS and PDSCH/PUSCH (or other 6G DL/UL data channels), and/or to determine for which resource elements (REs) to transmit/receive data in, and/or which REs to transmit/receive DMRS in.

Generally, embodiments herein include a method performed by a communication device configured for use in a communication network. The method comprises transmitting, to a network node in the communication network, signaling that indicates a demodulation reference signal, DMRS, capability of the communication device. In some embodiments, the DMRS capability includes support for the communication network co-scheduling DMRSs of different types for different communication devices. The method also comprises receiving a DMRS and/or a data channel for the communication device from the network node.

In some embodiments, DMRSs of different types include DMRSs associated with different lengths of frequency-domain orthogonal cover codes, OCCs.

In some embodiments, DMRSs of different types include DMRSs multiplexed over different numbers of code division multiplexing, CDM, groups.

In some embodiments, the DMRS capability includes support for the communication network co-scheduling a 3GPP Release 18 DMRS and a 3GPP Release 15 DMRS for different communication devices.

In some embodiments, the method further comprises making an assumption about whether any DMRS co-scheduled for a different communication device is of a different type than the DMRS for the communication device. In some embodiments, receiving the DMRS and/or a data channel for the communication device comprises receiving the DMRS and/or a data channel for the communication device based on the assumption. In some embodiments, according to the assumption the communication device does not expect the communication network to co-schedule DMRSs of different types for different communication devices. In some embodiments, the communication device is a 3GPP Release 18 communication device that supports both Release 18 DMRS and Release 15 DMRS, and wherein the assumption is that, if the communication device is scheduled with a Release 15 DMRS, the communication device does not expect to be co-scheduled with a Release 18 DMRS in the same CDM group. In some embodiments, receiving the DMRS and/or a data channel for the communication device based on the assumption comprises configuring a length of a discrete cosign transform, DCT, window filter of a receiver of the communication device based on the assumption and receiving the DMRS and/or the data channel for the communication device with the receiver as configured. In other embodiments, receiving the DMRS and/or a data channel for the communication device based on the assumption alternatively or additionally comprises, based on the assumption, determining which subcarriers contain DMRS from one or more other co-scheduled communication devices and estimating multi-user multiple-input multiple-output, MU-MIMO, interference based on the determined subcarriers. In yet other embodiments, receiving the DMRS and/or a data channel for the communication device based on the assumption alternatively or additionally comprises determining a power offset between the data channel and the DMRS for the communication device based on the assumption. In still yet other embodiments, receiving the DMRS and/or a data channel for the communication device based on the assumption alternatively or additionally comprises determining rate matching for the data channel based on the assumption. In still yet other embodiments, receiving the DMRS and/or a data channel for the communication device based on the assumption alternatively or additionally comprises, based on the assumption, determining in which resource elements to receive the data channel and/or in which resource elements to receive the DMRS for the communication device. In some embodiments, the method further comprises receiving, from the network node, radio resource control, RRC, signaling that indicates the communication device is able to make the assumption, and wherein the assumption is made based on the RRC signaling.

Other embodiments herein include a method performed by a network node configured for use in a communication network. The method comprises receiving, from a communication device, signaling that indicates a demodulation reference signal, DMRS, capability of the communication device. In some embodiments, the DMRS capability includes support for the communication network co-scheduling DMRSs of different types for different communication devices. The method also comprises transmitting a DMRS and/or a data channel for the communication device from the network node.

In some embodiments, DMRSs of different types include DMRSs associated with different lengths of frequency-domain orthogonal cover codes, OCCs.

In some embodiments, DMRSs of different types include DMRSs multiplexed over different numbers of code division multiplexing, CDM, groups.

In some embodiments, the DMRS capability includes support for the communication network co-scheduling a 3GPP Release 18 DMRS and a 3GPP Release 15 DMRS for different communication devices.

In some embodiments, the method further comprises transmitting, to the communication device, radio resource control, RRC, signaling indicating an assumption that the communication device is able to make about whether any DMRS co-scheduled for a different communication device is of a different type than the DMRS for the communication device. In some embodiments, the RRC signaling indicates the communication device is able to make an assumption that the communication network does not co-schedule DMRSs of different types for different communication devices. In some embodiments, the communication device is a 3GPP Release 18 communication device that supports both Release 18 DMRS and Release 15 DMRS, and wherein the RRC signaling indicates that, if the communication device is scheduled with a Release 15 DMRS, the communication device is able to assume that the communication device is not co-scheduled with a Release 18 DMRS in the same CDM group.

Other embodiments herein include a method performed by a communication device configured for use in a communication network. The method comprises making an assumption about whether any demodulation reference signal, DMRS, co-scheduled for a different communication device is of a type different than a type of a DMRS for the communication device. The method also comprises receiving the DMRS and/or a data channel for the communication device based on the assumption.

In some embodiments, DMRSs of different types include DMRSs associated with different lengths of frequency-domain orthogonal cover codes, OCCs.

In some embodiments, DMRSs of different types include DMRSs multiplexed over different numbers of code division multiplexing, CDM, groups.

In some embodiments, according to the assumption the communication device does not expect the communication network to co-schedule DMRSs of different types for different communication devices.

In some embodiments, the communication device is a 3GPP Release 18 communication device that supports both Release 18 DMRS and Release 15 DMRS, and the assumption is that, if the communication device is scheduled with a Release 15 DMRS, the communication device does not expect to be co-scheduled with a Release 18 DMRS in the same CDM group.

In some embodiments, receiving the DMRS and/or a data channel for the communication device based on the assumption comprises configuring a length of a discrete cosign transform, DCT, window filter of a receiver of the communication device based on the assumption and receiving the DMRS and/or the data channel for the communication device with the receiver as configured. In other embodiments, receiving the DMRS and/or a data channel for the communication device based on the assumption alternatively or additionally comprises, based on the assumption, determining which subcarriers contain DMRS from one or more other co-scheduled communication devices and estimating multi-user multiple-input multiple-output, MU-MIMO, interference based on the determined subcarriers. In yet other embodiments, receiving the DMRS and/or a data channel for the communication device based on the assumption alternatively or additionally comprises, determining a power offset between the data channel and the DMRS for the communication device based on the assumption. In still yet other embodiments, receiving the DMRS and/or a data channel for the communication device based on the assumption alternatively or additionally comprises determining rate matching for the data channel based on the assumption. In still yet other embodiments, receiving the DMRS and/or a data channel for the communication device based on the assumption alternatively or additionally comprises, based on the assumption, determining in which resource elements to receive the data channel and/or in which resource elements to receive the DMRS for the communication device.

In some embodiments, the method further comprises receiving, from the network node, radio resource control, RRC, signaling that indicates the communication device is able to make the assumption, and the assumption is made based on the RRC signaling.

Other embodiments herein include a communication device configured for use in a communication network. The communication device is configured to transmit, to a network node in the communication network, signaling that indicates a demodulation reference signal, DMRS, capability of the communication device. In some embodiments, the DMRS capability includes support for the communication network co-scheduling DMRSs of different types for different communication devices. The communication device is also configured to receive a DMRS and/or a data channel for the communication device from the network node.

In some embodiments, the communication device is configured to perform the steps described above for a communication device configured for use in a communication network.

Other embodiments herein include a network node configured for use in a communication network. The network node is configured to receive, from a communication device, signaling that indicates a demodulation reference signal, DMRS, capability of the communication device. In some embodiments, the DMRS capability includes support for the communication network co-scheduling DMRSs of different types for different communication devices. The network node is also configured to transmit a DMRS and/or a data channel for the communication device from the network node.

In some embodiments, the network node is configured to perform the steps described above for a network node configured for use in a communication network.

Other embodiments herein include a communication device configured for use in a communication network. The communication device is configured to make an assumption about whether any demodulation reference signal, DMRS, co-scheduled for a different communication device is of a type different than a type of a DMRS for the communication device. The communication device is also configured to receive the DMRS and/or a data channel for the communication device based on the assumption.

In some embodiments, the communication device is configured to perform the steps described above for a communication device configured for use in a communication network.

In some embodiments, a computer program comprising instructions which, when executed by at least one processor of a communication device, causes the communication device to perform the steps described above for a communication device configured for use in a communication network. In some embodiments, a computer program comprising instructions which, when executed by at least one processor of a network node, causes the network node to perform the steps described above for a network node configured for use in a communication network. In some embodiments, a carrier containing the computer program is one of an electronic signal, optical signal, radio signal, or computer readable storage medium.

Other embodiments herein include a communication device configured for use in a communication network. The communication device comprises communication circuitry and processing circuitry. The processing circuitry is configured to transmit, to a network node in the communication network, signaling that indicates a demodulation reference signal, DMRS, capability of the communication device. In some embodiments, the DMRS capability includes support for the communication network co-scheduling DMRSs of different types for different communication devices. The processing circuitry is also configured to receive a DMRS and/or a data channel for the communication device from the network node.

In some embodiments, the processing circuitry is configured to perform the steps described above for a communication device configured for use in a communication network.

Other embodiments herein include a network node configured for use in a communication network. The network node comprises communication circuitry and processing circuitry. The processing circuitry is configured to receive, from a communication device, signaling that indicates a demodulation reference signal, DMRS, capability of the communication device. In some embodiments, the DMRS capability includes support for the communication network co-scheduling DMRSs of different types for different communication devices. The processing circuitry is also configured to transmit a DMRS and/or a data channel for the communication device from the network node.

In some embodiments, the processing circuitry is configured to perform the steps described above for a network node configured for use in a communication network.

Other embodiments herein include a communication device configured for use in a communication network. The communication device comprises communication circuitry and processing circuitry. The processing circuitry is configured to make an assumption about whether any demodulation reference signal, DMRS, co-scheduled for a different communication device is of a type different than a type of a DMRS for the communication device. The processing circuitry is also configured to receive the DMRS and/or a data channel for the communication device based on the assumption.

In some embodiments, the processing circuitry is configured to perform the steps described above for a communication device configured for use in a communication network.

### BRIEF DESCRIPTION OF THE DRAWINGS

FIG. 1 is a block diagram of a communication network in accordance with some embodiments.

FIG. 2 is a block diagram of an example NR time-domain structure in accordance with some embodiments.

FIG. 3 is a block diagram of an NR physical time-frequency resource grid in accordance with some embodiments.

FIGS. 4A-4B are block diagrams of an example of type 1 and type 2 front-loaded DM-RS with single-symbol and double-symbol DM-RS and time domain mapping type A with first DM-RS in the third OFDM symbol of a transmission interval of 14 symbols in accordance with some embodiments.

FIG. 5 is a block diagram of some examples of DM-RS for mapping type A in accordance with some embodiments.

FIG. 6 is a block diagram of some examples of DM-RS for mapping type B in accordance with some embodiments.

FIG. 7 is a block diagram of an FD-OCC extension for DMRS Type 1 with 2 CDM groups in accordance with some embodiments.

FIG. 8 is a logic flow diagram of a method performed by a communication device configured for use in a communication device in accordance with particular embodiments.

FIG. 9 is a logic flow diagram of a method performed by a network node configured for use in a communication device in accordance with particular embodiments.

FIG. 10 is a logic flow diagram of a method performed by a communication device configured for use in a communication device in accordance with other particular embodiments.

FIG. 11 is a logic flow diagram of a method performed by a wireless device for PDSCH DMRS processing in accordance with other particular embodiments.

FIG. 12 is a block diagram of a communication device in accordance with some embodiments.

FIG. 13 is a block diagram of a network node in accordance with some embodiments.

FIG. 14 is a block diagram of a communication system in accordance with some embodiments.

FIG. 15 is a block diagram of a user equipment according to some embodiments.

FIG. 16 is a block diagram of a network node according to some embodiments.

FIG. 17 is a block diagram of a host according to some embodiments.

FIG. 18 is a block diagram of a virtualization environment according to some embodiments.

FIG. 19 is a block diagram of a host communicating via a network node with a UE over a partially wireless connection in accordance with some embodiments.

### DETAILED DESCRIPTION

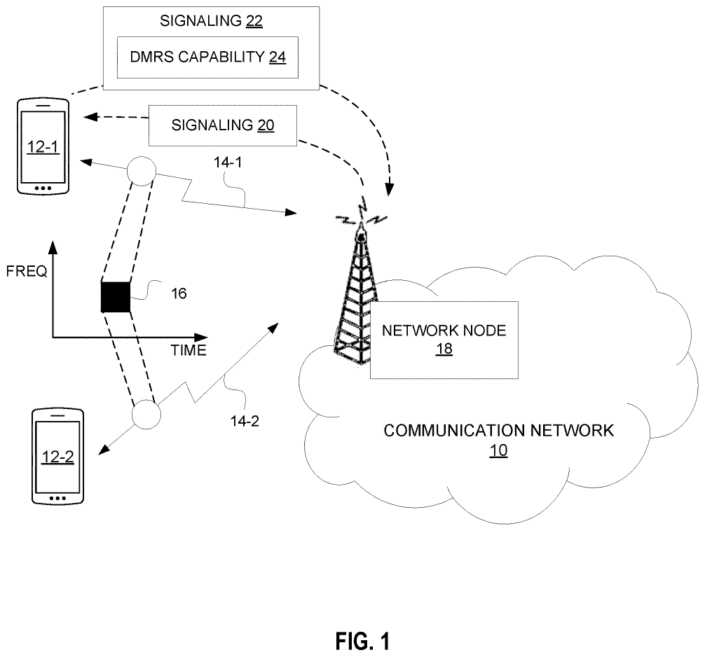

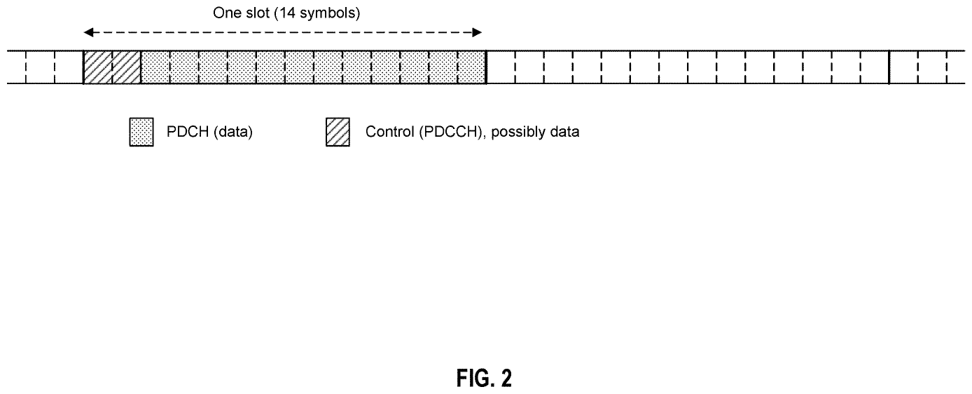

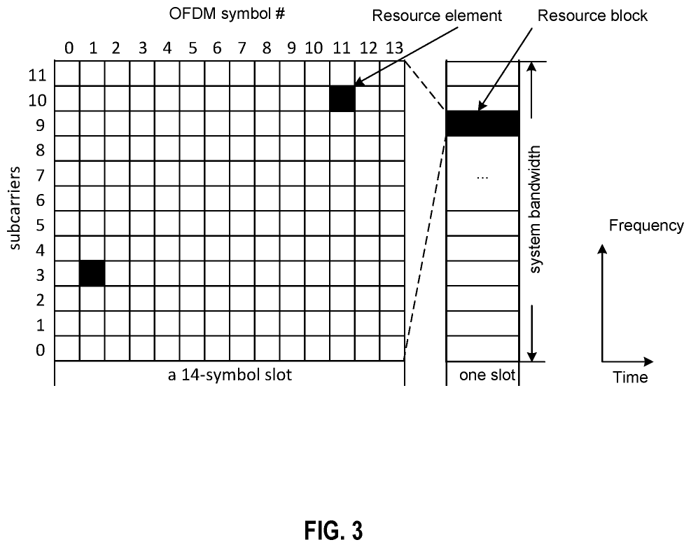

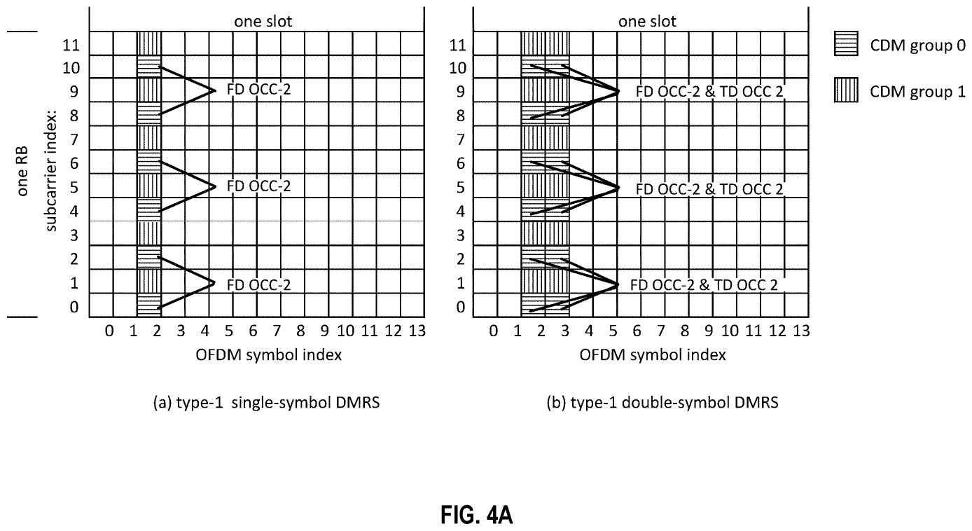

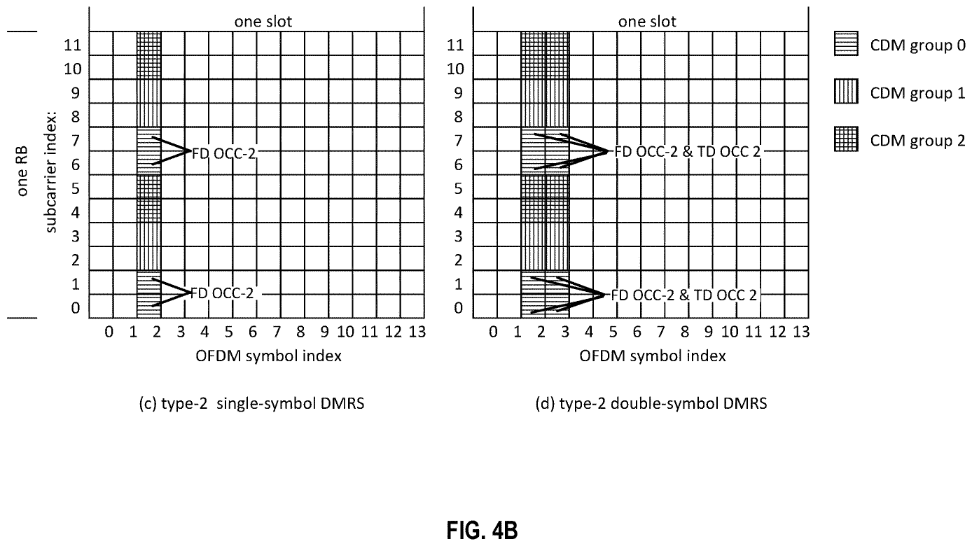

FIG. 1 shows a communication network 10 according to some embodiments, e.g., a 5G or 6G network. The communication network 10 provides communication service to communication devices 12, two of which are shown as communication devices 12-1 and 12-2. In doing so, the communication network 10 may co-schedule different communication devices 12-1, 12-2 in the sense that the communication network 10 schedules respective transmissions 14-1, 14-2 for the communication devices 12-1, 12-2 to occur in the same transmission resource 16, e.g., in the same time/frequency resource such as the same Resource Block (RB). The communication network 10 may for example exploit multi-user (MU) multiple input multiple output (MIMO), MU-MIMO, for such purpose.

In some embodiments, the respective transmissions 14-1, 14-2 for the communication devices 12-1, 12-2 include transmissions of respective data or control channels for the communication devices 12-1, 12-2, e.g., respective Physical Downlink Shared Channels (PDSCHs), respective Physical Downlink Control Channels (PDCCHs), or respective Physical Uplink Shared Channels (PUSCHs). In these and other embodiments, the respective transmissions 14-1, 14-2 include transmissions of respective demodulation reference signals (DMRSs) usable for coherent demodulation of the respective channels. A DMRS usable for coherent demodulation of a data or control channel may for instance be confined to the same time/frequency resource as that carrying the data or control channel, e.g., and be mapped on allocated resource elements in the time/frequency resource to facilitate time/frequency-selective fading radio channels.

The communication network 10 may employ different types of DMRSs. Different types of DMRSs may for example be based on different DMRS designs that target different use-cases, e.g., one design that targets increased DMRS capacity and one design that targets performance. In these and other embodiments, different types of DMRSs may be associated with different lengths of frequency-domain orthogonal cover codes (OCCs) and/or be multiplexed over different numbers of code division multiplexing (CDM) groups. Alternatively or additionally, different types of DMRSs may include a 3^{rd} Generation Partnership Project (3GPP) Release 18 DMRS and a 3GPP Release 15 DMRS. For example, in NR after Rel-18 (for DMRS Type 1), there might be two different DMRS types, the legacy DMRS type 1 (with comb 2) and a new extended Rel-18 DMRS type 1 with comb 4. Extended to 6G, there might be one new DMRS design that consist of two DMRS types (e.g. a first DMRS type with comb 2 and a second DMRS type with comb 4), such that a 6G UE supporting the new DMRS design dynamically can be scheduled with either comb 2 or comb 4 DMRS, in order to balance the DMRS performance vs DMRS capacity.

No matter the particular defining characteristic of DMRS types, some embodiments herein account for and/or accommodate for the communication network 10 co-scheduling different communication devices 12-1, 12-2 with DMRSs of different types, or in other words co-scheduling DMRSs of different types for different communication devices 12-1, 12-2. By doing so, some embodiments improve data channel performance and/or simplify receiver design.

FIG. 1 shows one or more such embodiments. As shown, a network node 18 in the communication network 10 transmits signaling 20 to communication device 12-1, e.g., RRC signaling or Downlink Control Information (DCI) signaling.

In some embodiments, the signaling 20 indicates information about a DMRS of co-scheduled communication device 12-2. The signaling 20 may for example include information as to whether or not a DMRS of co-scheduled communication device 12-2 is of the same DMRS type as a DMRS of communication device 12-1. The signaling 20 may do so for instance (i) by indicating whether or not a DMRS of co-scheduled communication device 12-2 is multiplexed in the same CDM group as a DMRS of communication device 12-1, (ii) by indicating whether or not a DMRS of co-scheduled communication device 12-2 is multiplexed in a CDM group that has the same CDM group index as that of a CDM group of a DMRS of communication device 12-1, and/or (iii) by indicating whether or not a DMRS of co-scheduled communication device 12-2 is multiplexed, in the same CDM group as a DMRS of communication device 12-1, using a longer frequency division OCC than a frequency division OCC with which a DMRS of communication device 12-1 is multiplexed in the CDM group.

Or, the signaling 20 may include information indicating a DMRS type of the DMRS of co-scheduled communication device 12-2. The signaling 20 may for instance include a bit field that explicitly indicates the DMRS type of the DMRS of co-scheduled communication device 12-2. Or, the signaling may indicate an index of a CDM group within which the DMRS of co-scheduled communication device 12-2 is multiplexed, where the index of the CDM group implicitly indicates the DMRS type of the DMRS of co-scheduled communication device 12-2. In still other embodiments, the signaling 20 may indicate a length of a frequency division OCC with which a DMRS of co-scheduled communication device 12-2 is multiplexed.

Alternatively or additionally, the signaling 20 indicates an assumption that communication device 12-1 is able to make about a DMRS of co-scheduled communication device 12-2. For example, the assumption may be an assumption that a DMRS of co-scheduled communication device 12-2 is, or is not, of the same DMRS type as a DMRS of communication device 12-1. Or, the assumption may be an assumption that a DMRS of co-scheduled communication device 12-2 is able to be, or is not able to be, of the same DMRS type as a DMRS of communication device 12-2. Or, in still other embodiments, the assumption may be an assumption of a DMRS type of a DMRS of co-scheduled communication device 12-2.

In the context of 3GPP Releases, the assumption in some embodiments may be that, if a DMRS of communication device 12-1 is a 3GPP Release 18 DMRS, a DMRS of co-scheduled communication device 12-2 cannot be a 3GPP Release 15 DMRS. Or, where communication device 12-1 is a 3GPP Release 18 communication device that supports both Release 18 DMRS and Release 15 DMRS, the assumption may be that, if the communication device 12-1 is scheduled with a Release 18 DMRS, the communication device 12-1 does not expect to be co-scheduled with a Release 15 DMRS in another CDM group. Or that, if the communication device 12-1 receives an antenna port indication associated with X number of CDM groups without data, CDM groups without data are associated with a Release 18 DMRS.

Or, more particularly, the assumption may be that, if communication device 12-1 is scheduled with a Rel-15 DMRS in Rel-15 CDM group 0, communication device 12-1 does not expect that another communication device 12-2 is co-scheduled with a Rel-18 DMRS in Rel-18 CDM group 0 or Rel-18 CDM group 2. In other embodiments, the assumption is alternatively or additionally that if communication device 12-1 is scheduled with a Rel-15 DMRS in Rel-15 CDM group 1, the communication device 12-1 does not expect that another communication device 12-2 is co-scheduled with a Rel-18 DMRS in Rel-18 CDM group 1 or Rel-18 CDM group 3. In yet other embodiments, the assumption is alternatively or additionally that if communication device 12-1 is scheduled with a Rel-15 DMRS in Rel-15 CDM group 0, the communication device 12-1 does not expect Rel-18 DMRS being scheduled on DMRS resource elements (Res) for Rel-15 CDM group 1. In still yet other embodiments, the assumption is alternatively or additionally that if communication device 12-1 is scheduled with a Rel-15 DMRS in Rel-15 CDM group 0, the communication device 12-1 does not expect to be co-scheduled with a Rel-18 DMRS in Rel-18 CDM group 1 or Rel-18 CDM group 3. In still yet other embodiments, the assumption is alternatively or additionally that if communication device 12-1 is scheduled with a Rel-15 DMRS in Rel-15 CDM group 1, the communication device 12-1 does not expect Rel-18 DMRS being scheduled on the DMRS REs for Rel-15 CDM group 0. In still yet other embodiments, the assumption is alternatively or additionally that if communication device 12-1 is scheduled with a Rel-15 DMRS in Rel-15 CDM group 1, the communication device 12-1 does not expect to be co-scheduled with a Rel-18 DMRS in Rel-18 CDM group 0 or Rel-18 CDM group 2.

In other embodiments where communication device 12-1 supports a first DMRS type with a length M FD-OCC code and a second DMRS type with a length N FD-OCC code, where N>M, the assumption may be that, if communication device 12-1 is scheduled with the first DMRS type, the communication device 12-1 does not expect to be co-scheduled with the second DMRS type in the same CDM group. Alternatively or additionally, in embodiments where communication device 12-1 supports a first DMRS type with M CDM groups and a second DMRS type with N CDM groups, where M>N, the assumption may be that, if communication device 12-1 is scheduled with the first DMRS type, the communication device 12-1 does not expect to be co-scheduled with the second DMRS type in another CDM group.

In any of these embodiments, then, the signaling 20 equips communication device 12-1 with information about whether to and/or how to account for and/or accommodate for the communication network 10 co-scheduling DMRSs of different types for different communication devices 12-1, 12-2. The signaling 20 may for example equip the communication device 12-1 with information about how to handle (e.g., receive) a data channel and/or DMRS for the communication device 12-1.

In fact, in some embodiments, communication device 12-1 receives a DMRS for the communication device 12-1, and/or a data channel of the communication device 12-1, based on the signaling 20. The communication device 12-1 may for instance configure a receiver of communication device 12-1 based on the signaling 20, and receive a DMRS of the communication device 12-1, and/or a data channel of the communication device 12-1, with the receiver as configured. For example, communication device 12-1 may configure a length of a discrete cosign transform (DCT) window filter of the receiver, based on the signaling 20. In particular, in embodiments where the signaling 20 indicates whether or not another communication device 12-2 is co-scheduled with the communication device 12-1 in the same CDM group, communication device 12-1 may configure the length of the DCT window filter to be shorter or longer depending respectively on whether or not another communication device 12-2 is co-scheduled with the communication device in the same CDM group. Or, where the signaling 20 indicates whether or not another communication device 12-2 with a longer frequency division OCC than that of the communication device 12-1 is co-scheduled with the communication device 12-1 in the same CDM group, the communication device 12-1 may configure the length of the DCT window filter to be shorter or longer depending respectively on whether or not another communication device 12-2 with a longer frequency division OCC than that of the communication device 12-1 is co-scheduled with the communication device 12-1 in the same CDM group.

Alternatively or additionally, communication device 12-1 may, based on the signaling 20, determine which subcarriers contain DMRS from one or more other co-scheduled communication devices 12-2 and estimate MU-MIMO interference. Or, the communication device 12-1 may determine a power offset between a data channel and a DMRS of the communication device 12-1 based on the signaling 20, and/or determine rate matching for a data channel based on the signaling 20.

In still other embodiments, communication device 12-1 may, based on the signaling 20, determine in which resource elements to receive a data channel and/or in which resource elements to receive a DMRS. In these and other embodiments, communication device 12-1 may receive a DMRS of the communication device 12-1 and process the received DMRS based on the signaling 20.

In these and other embodiments, then, communication device 12-1 accounts for and/or accommodates for the communication network 10 co-scheduling DMRSs of different types for different communication devices 12-1, 12-2. By accounting for and/or accommodating for such co-scheduling, communication device 12-1 supports (i.e., has the capability to handle) the communication network 10 co-scheduling DMRSs of different types for different communication devices 12-1, 12-2. The communication device 12-1 supporting the communication network 10 co-scheduling DMRSs of different types for different communication devices 12-1, 12-2 may mean, for example, that communication device 12-1 has the capability to receive signaling 20 from the communication network 10 indicates information about a DMRS of co-scheduled communication device 12-2 and/or indicating an assumption that communication device 12-1 is able to make about a DMRS of co-scheduled communication device 12-2. Alternatively or additionally, the communication device 12-1 supporting the communication network 10 co-scheduling DMRSs of different types for different communication devices 12-1, 12-2 may mean that communication device 12-1 has the capability to adapt its receiver and/or receiver processing to account for and/or accommodate for the communication network 10 co-scheduling DMRSs of different types for different communication devices 12-1, 12-2, e.g., by adapting the receiver DCT window filter.

Some embodiments herein nonetheless accommodate for not all communication devices having the capability to handle the communication network 10 co-scheduling DMRSs of different types for different communication devices 12-1, 12-2. In some embodiments, for example, the network node 18 performs scheduling based on which communication devices 12-1, 12-2 support the communication network 10 co-scheduling DMRSs of different types for different communication devices 12-1, 12-2, e.g., so as to avoid co-scheduling a communication device in a way that the communication device lacks the capability to handle.

Communication device 12-1 may accordingly assist the network node 18 in this regard by transmitting signaling 22 that indicates a DMRS capability 24 of communication device 12-1. In some embodiments, the DMRS capability 24 indicated by the signaling 22 includes support for the communication network 10 co-scheduling DMRSs of different types for different communication devices 12-1, 12-2. In embodiments where DMRSs of different types are associated with different lengths of frequency-domain OCCs, the DMRS capability 24 indicated by the signaling 22 may include support for the communication network 10 co-scheduling DMRS for different communication devices 12-1, 12-2 associated with different lengths of frequency-domain OCCs. Alternatively or additionally, in embodiments where DMRSs of different types include DMRSs multiplexed over different numbers of CDM groups, the DMRS capability 24 indicated by the signaling 22 may include support for the communication network 10 co-scheduling DMRS for different communication devices 12-1, 12-2 multiplexed over different numbers of CDM groups. In still other embodiments where different types of DMRSs include a 3GPP Release 18 DMRS and a 3GPP Release 15 DMRS, the DMRS capability 24 indicated by the signaling 22 may include support for the communication network 10 co-scheduling a 3GPP Release 18 DMRS and a 3GPP Release 15 DMRS for different communication devices 12-1, 12-2.

Regardless, in some embodiments, the signaling 22 indicates the DMRS capability 24 using a bit or flag whose value indicates whether communication device 12-1 supports the communication network 10 co-scheduling DMRSs of different types for different communication devices 12-1, 12-2. In other embodiments, the signaling 22 indicates the DMRS capability 24 using an optional information element (IE) whose mere presence indicates that communication device 12-1 supports the communication network 10 co-scheduling DMRSs of different types for different communication devices 12-1, 12-2.

Consider some examples of embodiments herein in a context of a 3GPP network, e.g., an NR network where communication devices 12 are exemplified as user equipments (UEs), and the network node 18 is exemplified as a gNB.

In one embodiment, one type of DMRS is a 3GPP Release 15 DMRS. In NR Rel-15, the mapping of a PDSCH DM-RS sequence r(m), m=0,1, . . . on antenna port p and subcarrier k in OFDM symbol l for the numerology index μ is specified in 3GPP TS 38.211 V15.10.0 as

$${a}_{k , l}^{( p , μ )} = {β}_{PUSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = {l}^{–} + {l}^{′}$$

$$n = 0 , 1 , …$$

where w_{f}(k′) represents a frequency domain length 2 OCC code and wₜ (l′) represents a time domain length 2 OCC code. Table 1 and Table 2 show the PDSCH DM-RS mapping parameters for configuration type 1 and type 2, respectively.

TABLE 1
PDSCH DM-RS mapping parameters for configuration type 1.

| | CDM | | w_{f} (k′) | | wₜ (l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DM-RS mapping parameters for configuration type 2.

| | CDM | | w_{f} (k′) | | wₜ (l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

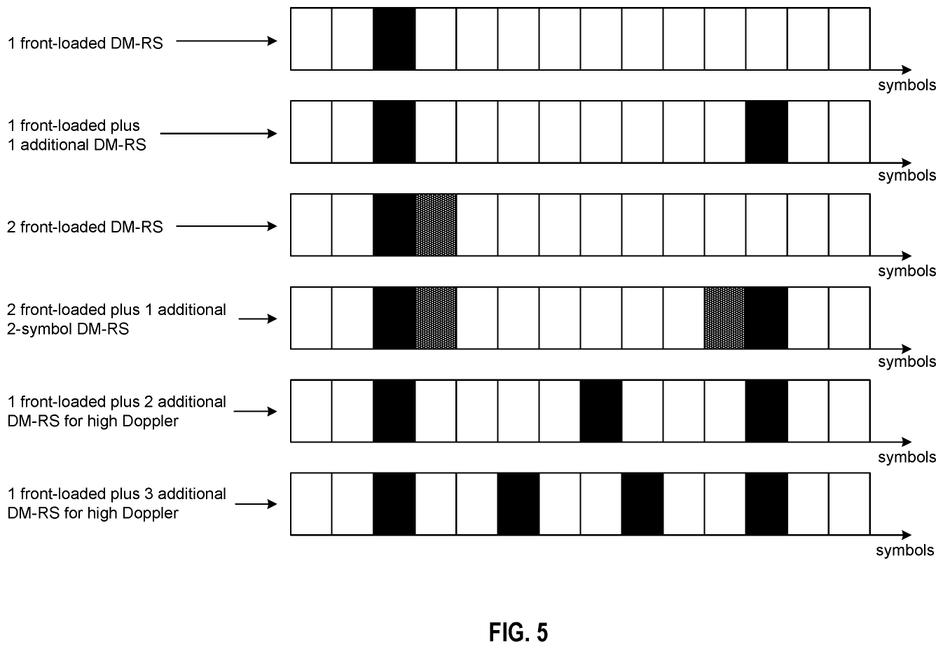

For PDSCH mapping type A, DM-RS mapping is relative to slot boundary. That is, the first front-loaded DM-RS symbol in DM-RS mapping type A is in either the 3^{rd} or 4^{th} symbol of the slot. In addition to the front-loaded DM-RS, type A DM-RS mapping can consist of up to 3 additional DM-RS. Some examples of DM-RS for mapping type A are shown in FIG. 5 (note that PDSCH length of 14 symbols is assumed in the examples). FIG. 5 assumes that the PDSCH duration is the full slot. If the scheduled PDSCH duration is shorter than the full slot, the positions of the DMRS changes according to the specification TS 38.211 V15.10.0.

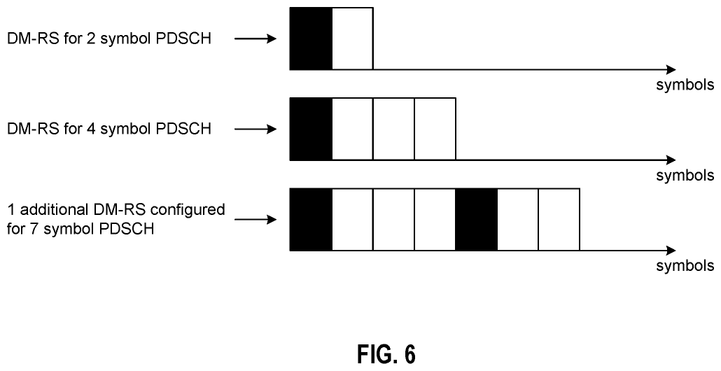

For PDSCH mapping type B, DM-RS mapping is relative to transmission start. That is, the first DM-RS symbol in DM-RS mapping type B is in the first symbol in which type B PDSCH starts. Some examples of DM-RS for mapping type B are shown in FIG. 6.

The same DMRS design for PDSCH is also applicable for PUSCH when transform precoding is not enabled, where the sequence r(m) shall be mapped to the intermediate quantity

$${\tilde{a}}_{k , l}^{( {\tilde{p}}_{j} , μ )}$$

for DMRS port \tilde{p}according to

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = {l}^{–} + {l}^{′}$$

$$n = 0 , 1 , …$$

$$j = 0 , 1 , … , υ - 1$$

where w_{f}(k′), wₜ (l′), and Δ are given by Tables 6.4.1.1.3-1 and 6.4.1.1.3-2 in TS 38.211 V15.10.0, which are reproduced below, and v is the number of PUSCH transmission layers. The intermediate quantity

$${\tilde{a}}_{k , l}^{( {\tilde{p}}_{j} , μ )} = 0$$

if Δ corresponds to any other antenna ports than \tilde{p}ⱼ.

The intermediate quantity

$${\tilde{a}}_{k , l}^{( {\tilde{p}}_{j} , μ )}$$

shall be precoded, multiplied with the amplitude scaling factor

$${β}_{PUSCH}^{DMRS}$$

in Order to conform to the transmit power specified in clause 6.2.2 of TS 38.214 V15.16.0, and mapped to physical resources according to

$$[ \begin{matrix}{a}_{k , l}^{( {p}_{o} , μ )} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {\tilde{p}}_{o} , μ )} \\ ⋮ \\ {\tilde{a}}_{k , l}^{( {\tilde{p}}_{υ - 1} , μ )}\end{matrix} ]$$

where
the precoding matrix W is given by clause 6.3.1.5 of TS 38.211 V15.10.0,
{p_{0, . . . ,} p_{ρ-1}} is a set of physical antenna ports used for transmitting the PUSCH, and
{\tilde{p}_{0, . . . ,} \tilde{p}ᵥ₋₁} is a set of DMRS ports for the PUSCH;

TABLE 6.4.1.1.3-1
Parameters for PUSCH DM-RS configuration type 1.

| | CDM | | w_{f} (k′) | | wₜ (l′) | |
|---|---|---|---|---|---|---|
| \tilde{p} | group λ | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 6.4.1.1.3-2
Parameters for PUSCH DM-RS configuration type 2.

| | CDM | | w_{f} (k′) | | wₜ (l′) | |
|---|---|---|---|---|---|---|
| \tilde{p} | group λ | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | + 1 | −1 |
| 10 | 2 | 4 | +1 | +1 | +1 | −1 |
| 11 | 2 | 4 | +1 | −1 | +1 | −1 |

### DMRS Sequence Generation

The 3GPP Release 15 DMRS sequence r(n) for both PDSCH and PUSCH is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1 of TS 38.211 V15.10.0. The pseudo-random sequence generator is initialized with

$${c}_{i n i t} = ( {2}^{17} ( {N}_{s y m b}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot,

$${n}_{s , f}^{μ}$$

is the slot number within a frame.

For PDSCH DMRS,

$${N}_{ID}^{0} , {N}_{ID}^{1}$$

∈{0,1, . . . , 65535} are given by the higher-layer parameters scramblingID0 and scramblingID1, respectively, in the DMRS-DownlinkConfig IE if provided and the PDSCH is scheduled by PDCCH using DCI format 1_1 or 1_2 with the Cyclic Redundancy Check (CRC) scrambled by Cell Radio Network Temporary Identifier (C-RNTI), Modulation Coding Scheme C-RNTI (MCS-C-RNTI), or Configured Scheduling RNTI (CS-RNTI).

For PUSCH DMRS,

$${N}_{ID}^{0} , {N}_{ID}^{1}$$

∈{0,1, . . . , 65535} are given by the higher-layer parameters scramblingID0 and scramblingID1, respectively, f in the DMRS-UplinkConfig IE if provided and the PUSCH is scheduled by DCI format 0_1 or 0_2, or by a PUSCH transmission with a configured grant.

For PUSCH DMRS,

$${N}_{ID}^{0} {N}_{ID}^{0} , {N}_{ID}^{1}$$

∈{0,1, . . . , 65535} are, for each msgA PUSCH configuration, given by the higher-layer parameters msgA-ScramblingID0 and msgA-ScramblingID1, respectively, in the msgA-DMRS-Config IE if provided and the PUSCH transmission is triggered by a Type-2 random access.

For PDSCH DMRS,

$${N}_{ID}^{0}$$

∈{0,1, . . . , 65535} given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI.

For PUSCH DMRS,

$${N}_{ID}^{0}$$

∈{0,1, . . . , 65535} is given by the higher-layer parameter scramblingID0 in the DMRS-UplinkConfig IE if provided and the PUSCH is scheduled by DCI format 0_0 with the CRC scrambled by C-RNTI, MCS-C-RNTI, or CS-RNTI.

$${N}_{ID}^{{{n}^{–}}_{SCID}^{{λ}^{–}}} = {N}_{ID}^{cell} otherwise ;$$

$${{n}^{–}}_{SCID}^{{λ}^{–}}$$

and λ̅ are given by the following.

If the higher-layer parameter dmrs-Downlink in the DMRS-DownlinkConfig IE or dmrs-Uplink in the DMRS-UplinkConfig IE is provided, the corresponding

$${{n}^{–}}_{SCID}^{{λ}^{–}}$$

and λ̅ are determined as

$${\overline{n}}_{S C l D}^{\overline{λ}} = \overline{λ} = λ$$

where Δ is the CDM group index.

Otherwise, the corresponding

$${{n}^{–}}_{SCID}^{{λ}^{–}}$$

and λ̅ are determined as:

$${{n}^{–}}_{SCID}^{{λ}^{–}} = {n}_{SCID}$$

$${λ}^{–} = 0$$

The quantity n_{SCID}∈{0, 1} is given by the DM-RS sequence initialization field, if present, in the DCI associated with the PDSCH transmission if DCI format 1_1 or 1_2 is used or the PUSCH transmission if DCI format 0_1 or 0_2 is used, or indicated by the higher layer parameter dmrs-SeqInitialization, if present, for a Type 1 PUSCH transmission with a configured grant; otherwise n_{SCID}=0.

### DMRS Ports Signaling

3GPP Release 15 DMRS port(s) for a PDSCH or a PUSCH are signaled in the corresponding scheduling DCI. In addition to the DMRS ports, the number of CDM groups that are not allocated for PDSCH or PUSCH and also the number of front-loaded DMRS symbols are dynamically signaled in the DCI.

“Antenna port” field in DCI 1_1 is defined as following in 3GPP TS 38.212 V15.13.0:

Antenna port(s)-4, 5, or 6 bits as defined by Tables 7.3.1.2.2-1/2/3/4 and Tables 7.3.1.2.2-1A/2A/3A/4A, where the number of CDM groups without data of values 1, 2, and 3 refers to CDM groups {0}, {0,1}, and {0, 1,2} respectively. The antenna ports {p_{0, . . . ,} pᵥ₋₁} shall be determined according to the ordering of DMRS port(s) given by Tables 7.3.1.2.2-1/2/3/4 or Tables 7.3.1.2.2-1A/2A/3A/4A. When a UE receives an activation command that maps at least one codepoint of DCI field ‘Transmission Configuration Indication’ to two TCI states, the UE shall use Table 7.3.1.2.2-1A/2A/3A/4A; otherwise, it shall use Tables 7.3.1.2.2-1/2/3/4. The UE can receive an entry with DMRS ports equals to 1000, 1002, 1003 when two TCI states are indicated in a codepoint of DCI field ‘Transmission Configuration Indication’.

If a UE is configured with both dmrs-DownlinkForPDSCH-MappingTypeA and dmrs-DownlinkForPDSCH-MappingTypeB, the bitwidth of this field equals max{x_{A}, x_{B}} where x_{A} is the “Antenna ports” bitwidth derived according to dmrs-DownlinkForPDSCH-MappingTypeA and x_{B} is the “Antenna ports” bitwidth derived according to dmrs-DownlinkForPDSCH-MappingTypeB. A number of |x_{A}-x_{B} zeros are padded in the MSB of this field, if the mapping type of the PDSCH corresponds to the smaller value of x_{A} and x_{B}.

“Antenna port” field in DCI 1_2 and DCI 0_2 is 0 bit if higher layer parameter, antennaPortsFieldPresentDCI-1-2 and antennaPortsFieldPresenceDCI-0-2 respectively, is not configured. The antenna port(s) are defined assuming bit field index value 0 in Tables 7.3.1.2.2-1/2/3/4 for DCI 1_2 and 7.3.1.1.2-6 to 7.3.1.1.2-23 for DCI 0_2.

In PUSCH scheduling, the number of layers are indicated separately from DMRS ports signaling in the DCI. While for PDSCH scheduling, the number of layers and DMRS ports are signaled jointly in the DCI.

An “antenna port(s)” bit field in DCI is used for the purpose. An example for type 1 DMRS with rank=1 and up to two maximum number of front-loaded DMRS OFDM symbols for PUSCH is shown in Table 7.3.1.1.2-12 below, which is copied from 3GPP TS 38.212 V15.13.0. Here 4bits are used for the bitwidth of the ‘antenna port(s)’ field. Note that DMRS type and maximum number of front-loaded DMRS symbols are semi-statically configured by RRC.

TABLE 7.3.1.1.2-12
Antenna port(s), transform precoder is disabled,
dmrs-Type = 1, maxLength = 2, rank = 1

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Another example for type 1 DMRS with up to two maximum number of front-loaded DMRS OFDM symbols for PDSCH is shown in Table 7.3.1.2.2-2 below, which is copied from 3GPP TS 38.212 V15.13.0.

TABLE 7.3.1.2.2-2
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

In Rel-16 M-TRP PDSCH, a new row with indices value 31 is added to existing antenna port table. When a Medium Access Control (MAC) Control Element (CE) activates any of the Transmission Configuration Indicator (TCI) field codepoints associated with 2 TCI states, the table containing the new row is used to indicate which of the ports are used for PDSCH for each Transmission Reception Point (TRP).

TABLE 7.3.1.2.2-2A
Antenna port(s) (1000 + DMRS port), dmrs-Type = 1, maxLength = 2 (from TS38.212
V16.10.0 of 3GPP)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

### DCI 1_0, DCI 0_0

DCI 1_0 is fallback DCI for downlink, DCI 0_0 is fallback DCI for uplink. It is specified in NR that DCI 1_0 applies only the Type 1 DMRS, because DCI 1_0 can be used to signal paging message and system information which are broadcasted for all UEs. While DCI 0_0 can apply either Type 1 or Type2, whichever is the configured DMRS type as in DMRS-Config under PUSCH-Config or configuredGrantConfig from UE specific signaling.

### SU-MIMO and Co-Scheduling of UE in the Downlink

For antenna port tables defined for each DMRS type, some of the indices are specified to be used only for Single User (SU) Multiple Input Multiple Output (MIMO). For the remaining indices that can be used for Multiple User (MU) MIMO, the UE heretofore assumes the co-scheduled UE are scheduled with the same DMRS-type and the same number of DMRS symbols.

For DM-RS configuration type 1,
if a UE is scheduled with one codeword and assigned with the antenna port mapping with indices of {2, 9, 10, 11 or 30} in Table 7.3.1.2.2-1 and Table 7.3.1.2.2-2 of Clause 7.3.1.2 of TS 38.212, or
if a UE is scheduled with one codeword and assigned with the antenna port mapping with indices of {2, 9, 10, 11 or 12} in Table 7.3.1.2.2-1A and {2, 9, 10, 11, 30 or 31} in Table 7.3.1.2.2-2A of Clause 7.3.1.2 of TS 38.212, or
if a UE is scheduled with two codewords,
   the UE may assume that all the remaining orthogonal antenna ports are not associated with transmission of PDSCH to another UE.

For DM-RS configuration type 2,
if a UE is scheduled with one codeword and assigned with the antenna port mapping with indices of {2, 10 or 23} in Table 7.3.1.2.2-3 and Table 7.3.1.2.2-4 of Clause 7.3.1.2 of TS38.212, or
if a UE is scheduled with one codeword and assigned with the antenna port mapping with indices of {2, 10, 23 or 24} in Table 7.3.1.2.2-3A and {2, 10, 23 or 58} in Table 7.3.1.2.2-4A of Clause 7.3.1.2 of TS 38.212, or
if a UE is scheduled with two codewords,
   the UE may assume that all the remaining orthogonal antenna ports are not associated with transmission of PDSCH to another UE.

Regarding co-scheduling, a UE in NR can be indicated by a pointer to an entry in an antenna port table if another UE is co-scheduled at the same time/frequency resources (i.e., if the UE is scheduled for MU-MIMO), by pointing at an entry in the antenna port table that indicates that the “number of CDM groups without data” is larger than 0. In current NR DMRS Type 1, where only two CDM groups exist, the maximum “number of CDM groups without data” is equal to one, while for NR DMRS design Type 2, where three CDM groups exist, the maximum “number of CDM groups without data” is equal to two.

For Rel-18 it is possible that the number of CDM groups are extended to 4 for Type 1 DMRS, and to 6 for Type 2 DMRS. Assume that a Rel-18 UE is triggered with legacy DMRS design Type 1 (with two CDM groups), and that the UE is indicated with an entry in the antenna port table that the “number of CDM groups without data” is equal to 1. Then the UE will heretofore not know if the other UE is scheduled with legacy DMRS type 1 (and hence use comb 2 for DMRS) or if the other UE is scheduled with the extended Rel-18 DMRS type 1 (and hence use comb 4). Since the DMRS power offset and PUSCH/PDSCH rate matching depends on which sub-carriers are used for DMRS and which are used for data, there might be issues with the receiver of the DMRS.

As another example, for the increased FD-OCC length solution (either FD-OCC length 4 or 6), for PDSCH, a UE scheduled with Rel-15 DMRS (FD-OCC length 2) might heretofore not know if it is co-scheduled with another Rel-15 DMRS or a Rel-18 DMRS in the same CDM group. Since different receiver methods are optimal depending on if co-scheduled UEs are using Rel-15 DMRS or Rel-18 DMRS, it is heretofore an issue that the UE does not know if a co-scheduled UE is using legacy DMRS or new DMRS design.

In 6G, UEs might be implemented with a new DMRS design that is aimed for optimizing both SU-MIMO and MU-MIMO (for example the new DMRS design might support both comb 2 (used to optimize SU-MIMO) and comb 4 or larger to optimize the capacity for MU-MIMO). In this case, the issues described above might become applicable also for 6G.

Some embodiments herein advantageously provide a framework and/or signaling to indicate the DMRS design for co-scheduled UEs, e.g., for 5G advanced and/or 6G.

Some embodiments for example provide improved PDSCH performance since the UE can adapt its receiver algorithms according to the indicated co-scheduled PDSCH DMRS type, and/or the UE can simplify the UE receiver design based on knowledge that co-scheduled UEs will have a certain DMRS design. Alternatively or additionally, since rate matching and DMRS power boost may depend on the number of sub-carriers used for DMRS and data, some embodiments enable the UE to determine the correct power offset between DRMS and PDSCH/PUSCH (or other 6G DL/UL data channels), and/or to determine for which resource elements (Res) to transmit/receive data in, and/or which REs to transmit/receive DMRS in.

Some embodiments herein are exemplified in for a Physical Downlink Shared Channel (PDSCH). However, the embodiments are extendable to a Physical Uplink Shared Channel (PUSCH) or another type of downlink or uplink data channel, e.g., specified in 6G+.

### Prohibit Scheduling Rel-15 DMRS and Rel-18 DMRS

In one embodiment, a UE supporting a first DMRS type with a length M FD-OCC code, and a second DMRS type with a length N FD-OCC code (where N>M), and where the UE is scheduled with the first DMRS type, the UE does not expect to be co-scheduled with the second DMRS type in the same CDM group. In case increased FD-OCC length is used for the Rel-18 DMRS design, this would mean that a Rel-18 UE supporting both Rel-18 and Rel-15 PDSCH DMRS and scheduled with a Rel-15 PDSCH DMRS is not expected to be co-scheduled with a Rel-18 PDSCH DMRS in the same CDM group. One benefit with this embodiment is that the UE always can use a DCT receiver with larger time window, which will make the performance of the PDSCH less sensitive to delay spread in the channel. This will simplify the UE receiver design and reduce the cost for UEs.

In one embodiment, a UE supporting a first DMRS type with M CDM groups, and a second DMRS type with N CDM groups (where M>N), and where the UE is scheduled with the first DMRS type (i.e., with a DMRS type with most CDM groups), the UE does not expect to be co-scheduled with the second DMRS type in another CDM group. In case an increased number of CDM groups is used for the Rel-18 DMRS design, this would mean that a Rel-18 UE supporting both Rel-18 and Rel-15 PDSCH DMRS and scheduled with a Rel-18 PDSCH DMRS is not expected to be co-scheduled with a Rel-15 PDSCH DMRS in another CDM group. This means that, when the UE is indicated with an antenna port indication associated with X number of CDM groups without data (in the scheduling DCI), the UE knows that the CDM groups without data are associated with the new Rel-18 DMRS design. In this way the UE will be able to determine for example which sub-carriers that contain DMRS from other co-scheduled UEs, and can in this way determine the estimated MU-MIMO cross UE interference, etc.

These embodiments exemplify Embodiments AAA1-AAA24 enumerated below.

### Dynamic Indication of Rel-18 and Rel-15 DMRS Designs

In one embodiment, a new bitfield in DCI scheduling a PDSCH for a UE is used to indicate if another UE is co-scheduled with the UE and if the co-scheduled UE are using PDSCH DMRS that are of the same or different DMRS type.

In one embodiment, a bitfield is used to indicate if another UE is co-scheduled in the same CDM group or not. If no other UE is co-scheduled in the same CDM group, the UE can adapt its receiver (for example use a longer DCT window filter), which makes the PDSCH performance more robust towards delay spread in the channel.

In one embodiment, a bitfield is used to indicate if another UE with longer FD-OCC codes is co-scheduled in the same CDM group. If no other UE is co-scheduled in the same CDM group with longer FD-OCC code, the UE can adapt its receiver (for example use a longer DCT window filter), which makes the PDSCH performance more robust towards delay spread in the channel.

These embodiments exemplify Embodiments A1-A16, A19-A35, B1-B16, and B19-B22 enumerated below.

### RRC Indication of Co-Scheduling Rel-15 DMRS and Rel-18 DMRS

In one embodiment, RRC configuration is used to indicate if a UE should assume that a co-scheduled UE could be configured with a separate PDSCH DMRS type or if co-schedule UEs only can be configured with the same DMRS type. For example, a new parameter in DMRS-DownlinkConfig IE could be used to indicate that the UE should assume that if it is scheduled with PDSCH DMRS with Rel-18 DMRS design, another UE can/cannot be scheduled with a PDSCH DMRS of Rel-15 DMRS design. With this knowledge the UE can adapt its receiver accordingly.

In one embodiment, the used CDM groups for each DMRS type are configured in higher layer.

These embodiments exemplify Embodiments A1-A8, A11-A35, B1-B8, and B11-B22 enumerated below.

### Implicit Indication of Co-Scheduling Rel-18 and Rel-15 DMRS

In one embodiment, the index of CDM groups is used to explicitly indicate the DMRS type of co-scheduled UEs.

In one example, Rel-15 DMRS is always scheduled with a CDM group of lower index, Rel-18 DMRS is scheduled with a CDM group which maps to higher index then the Rel-15 CDM group.

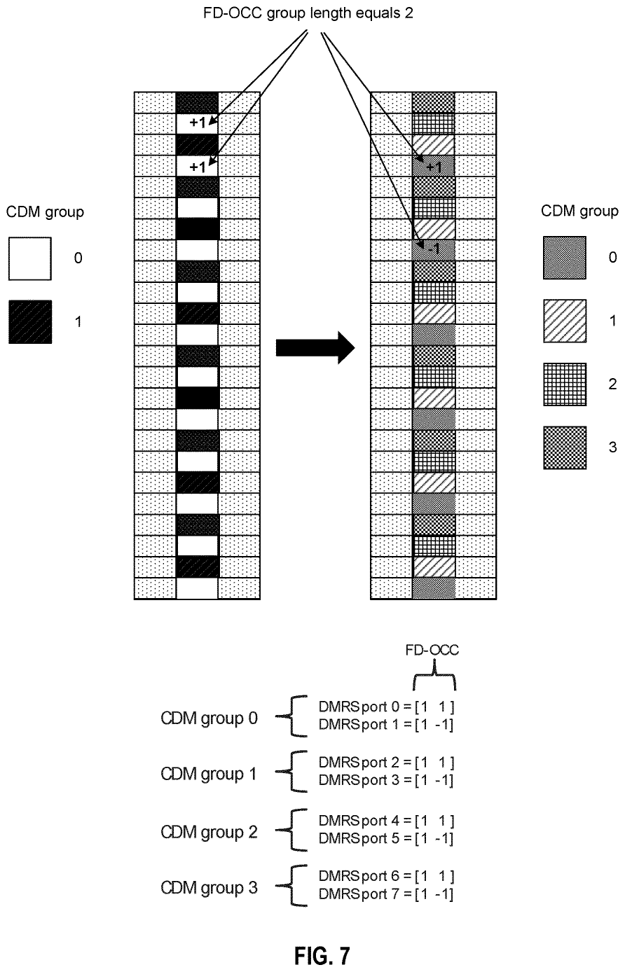

For FD-OCC extension for DMRS Type 1 with 2 CDM groups, this means a UE scheduled with Rel-15 DMRS is indicated with CDM group 0, UEs scheduled with Rel-18 DMRS is indicated with CDM group 1; if a UE is indicated with Rel-15 DMRS with CDM group 1, it does not expect a co-scheduled UE in CDM group 0 using Rel-18 DMRS. For FDM extension of DMRS Type 1, the number of CDM groups increases from 2 to 4. As is shown in FIG. 7, the DMRS pattern to the left is Rel-15 DMRS Type 1 with 2 CDM groups, and the DMRS pattern to the right is assumed to be the Rel-18 FDM extension of Type 1, with 4 CDM groups. Observe the REs used for Rel-15 DMRS CDM group 0 (light blue) is used for Rel-18 DMRS CDM group 0 (purple) and CDM group 2 (dark blue); and the REs used for Rel-15 DMRS CDM group 1 is used for Rel-18 DMRS CDM group 1 and CDM group 3.

In one embodiment, if a UE is scheduled with a Rel-15 DMRS in Rel-15 CDM group 0, the UE does not expect that another UE is co-scheduled with a Rel-18 DMRS in Rel-18 CDM group 0 or Rel-18 CDM group 2 (since then it will be difficult for the UE to separate the interfering DMRS for the co-scheduled UE from the own DMRS).

In one embodiment, if a UE is scheduled with a Rel-15 DMRS in Rel-15 CDM group 1, the UE does not expect that another UE is co-scheduled with a Rel-18 DMRS in Rel-18 CDM group 1 or Rel-18 CDM group 3 (since then it will be difficult for the UE to separate the interfering DMRS for the co-scheduled UE from the own DMRS).

In one embodiment, if a UE is scheduled with a Rel-15 DMRS in Rel-15 CDM group 0, it does not expect Rel-18 DMRS being scheduled on the DMRS REs for Rel-15 CDM group 1, i.e., the UE does not expect to be co-scheduled with a Rel-18 DMRS in Rel-18 CDM group 1 or Rel-18 CDM group 3.

In one embodiment, if a UE is scheduled with a Rel-15 DMRS in Rel-15 CDM group 1, it does not expect Rel-18 DMRS being scheduled on the DMRS REs for Rel-15 CDM group 0, i.e., the UE does not expect to be co-scheduled with a Rel-18 DMRS in Rel-18 CDM group 0 or Rel-18 CDM group 2.

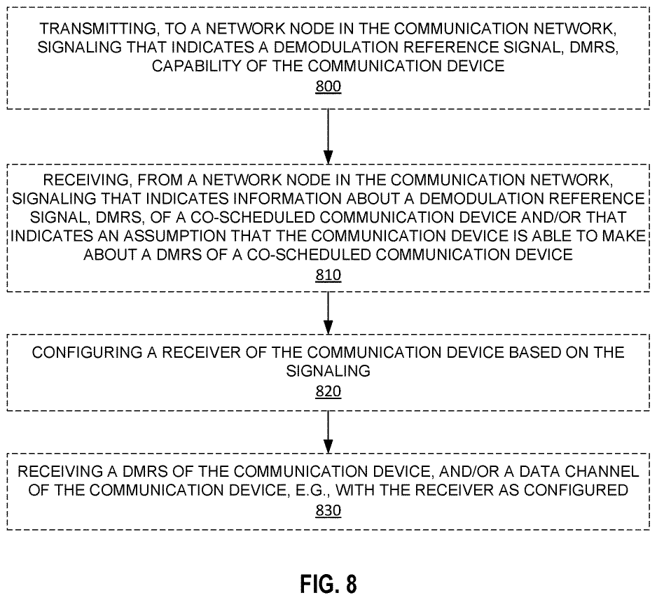

In view of the modifications and variations herein, FIG. 8 depicts a method performed by a communication device 12-1, 12-2 configured for use in a communication network 10 in accordance with particular embodiments. The method includes receiving, from a network node 18 in the communication network 10, signaling 20 that indicates information about a demodulation reference signal, DMRS, of a co-scheduled communication device 12-2 and/or that indicates an assumption that the communication device 12-1 is able to make about a DMRS of a co-scheduled communication device 12-2 (Block 810).

In some embodiments, the signaling 20 indicates information about a DMRS of a co-scheduled communication device 12-2. In some embodiments, the information about a DMRS of a co-scheduled communication device 12-2 includes information as to whether or not a DMRS of a co-scheduled communication device 12-2 is of the same DMRS type as a DMRS of the communication device 12-1. In some embodiments, the information about a DMRS of a co-scheduled communication device 12-2 includes information indicating a DMRS type of the DMRS of the co-scheduled communication device 12-2. In some embodiments, the signaling 20 includes a bit field that explicitly indicates the DMRS type of the DMRS of the co-scheduled communication device 12-2. In some embodiments, the signaling 20 indicates an index of a code division multiplexing, CDM, group within which the DMRS of the co-scheduled communication device 12-2 is multiplexed, wherein the index of the CDM group implicitly indicates the DMRS type of the DMRS of the co-scheduled communication device 12-2. In some embodiments, the information about a DMRS of a co-scheduled communication device 12-2 includes information as to whether or not a DMRS of a co-scheduled communication device 12-2 is multiplexed in the same code division multiplexing, CDM, group as a DMRS of the communication device 12-1. In other embodiments, the information about a DMRS of a co-scheduled communication device 12-2 includes information as to whether or not a DMRS of a co-scheduled communication device 12-2 is multiplexed in a code division multiplexing, CDM, group that has the same CDM group index as that of a CDM group of a DMRS of the communication device 12-1. In yet other embodiments, the information about a DMRS of a co-scheduled communication device 12-2 includes information indicating a CDM group or CDM group index of a DMRS of a co-scheduled communication device 12-2. In some embodiments, the information about a DMRS of a co-scheduled communication device 12-2 includes information as to whether or not a DMRS of a co-scheduled communication device 12-2 is multiplexed, in the same code division multiplexing, CDM, group as a DMRS of the communication device 12-1, using a longer frequency division orthogonal cover code, OCC, than a frequency division OCC with which a DMRS of the communication device 12-1 is multiplexed in the CDM group. In other embodiments, the information about a DMRS of a co-scheduled communication device 12-2 includes information indicating a length of a frequency division OCC with which a DMRS of a co-scheduled communication device 12-2 is multiplexed. In some embodiments, the signaling 20 is included in a physical layer control message that schedules a data channel for the communication device 12-1. In some embodiments, the physical layer control message is a Downlink Control Information, DCI, message.

In some embodiments, the signaling 20 indicates an assumption that the communication device 12-1 is able to make about a DMRS of a co-scheduled communication device 12-2. In some embodiments, the assumption is an assumption that a DMRS of a co-scheduled communication device 12-2 is, or is not, of the same DMRS type as a DMRS of the communication device 12-1. In some embodiments, the assumption is an assumption that a DMRS of a co-scheduled communication device 12-2 is able to be, or is not able to be, of the same DMRS type as a DMRS of the communication device 12-1. In some embodiments, the assumption is that, if a DMRS of the communication device 12-1 is a 3GPP Release 18 DMRS, a DMRS of a co-scheduled communication device 12-2 cannot be a 3GPP Release 15 DMRS. In some embodiments, the assumption is that if the communication device 12-1 is scheduled with a Rel-15 DMRS in Rel-15 CDM group 0, the communication device 12-1 does not expect that another communication device 12-2 is co-scheduled with a Rel-18 DMRS in Rel-18 CDM group 0 or Rel-18 CDM group 2. In other embodiments, the assumption is alternatively or additionally that if the communication device 12-1 is scheduled with a Rel-15 DMRS in Rel-15 CDM group 1, the communication device 12-1 does not expect that another communication device 12-2 is co-scheduled with a Rel-18 DMRS in Rel-18 CDM group 1 or Rel-18 CDM group 3. In yet other embodiments, the assumption is alternatively or additionally that if the communication device 12-1 is scheduled with a Rel-15 DMRS in Rel-15 CDM group 0, the communication device 12-1 does not expect Rel-18 DMRS being scheduled on DMRS resource elements, Res, for Rel-15 CDM group 1. In still yet other embodiments, the assumption is alternatively or additionally that if the communication device 12-1 is scheduled with a Rel-15 DMRS in Rel-15 CDM group 0, the communication device 12-1 does not expect to be co-scheduled with a Rel-18 DMRS in Rel-18 CDM group 1 or Rel-18 CDM group 3. In still yet other embodiments, the assumption is alternatively or additionally that if the communication device 12-1 is scheduled with a Rel-15 DMRS in Rel-15 CDM group 1, the communication device 12-1 does not expect Rel-18 DMRS being scheduled on the DMRS REs for Rel-15 CDM group 0. In still yet other embodiments, the assumption is alternatively or additionally that if the communication device 12-1 is scheduled with a Rel-15 DMRS in Rel-15 CDM group 1, the communication device 12-1 does not expect to be co-scheduled with a Rel-18 DMRS in Rel-18 CDM group 0 or Rel-18 CDM group 2. In some embodiments, the assumption is an assumption of a DMRS type of a DMRS of a co-scheduled communication device 12-2. In some embodiments, the signaling 20 is radio resource control, RRC, signaling 20. In some embodiments, the RRC signaling 20 includes a DMRS-DownlinkConfig information element that indicates the assumption that the communication device 12-1 is able to make.

In some embodiments, the signaling 20 also indicates whether or not another communication device 12-2 is co-scheduled with the communication device 12-1.

In some embodiments, the signaling 20 also indicates whether or not another communication device 12-2 is co-scheduled with the communication device 12-1 in the same code division multiplexing, CDM, group.

In some embodiments, the signaling 20 indicates whether or not another communication device 12-2 with a longer DMRS frequency division orthogonal cover code than that of the communication device 12-1 is co-scheduled with the communication device 12-1 in the same code division multiplexing, CDM, group.

In some embodiments, the method also includes receiving a DMRS of the communication device 12-1, and/or a data channel of the communication device 12-1, e.g., with the receiver as configured. (Block 830).

In some embodiments, the method also includes configuring a receiver of the communication device 12-1 based on the signaling 20 (Block 820). In some embodiments, said configuring comprises configuring a length of a discrete cosign transform, DCT, window filter of the receiver. In some embodiments, the method further comprises receiving a DMRS of the communication device 12-1, and/or a data channel of the communication device 12-1, with the receiver as configured. In some embodiments, the signaling 20 indicates whether or not another communication device 12-2 is co-scheduled with the communication device 12-1 in the same code division multiplexing, CDM, group, and said configuring comprises configuring the length of the DCT window filter to be shorter or longer depending respectively on whether or not another communication device 12-2 is co-scheduled with the communication device 12-1 in the same CDM group. In some embodiments, the signaling 20 indicates whether or not another communication device 12-2 with a longer frequency division orthogonal cover code than that of the communication device 12-1 is co-scheduled with the communication device 12-1 in the same code division multiplexing, CDM, group, and said configuring comprises configuring the length of the DCT window filter to be shorter or longer depending respectively on whether or not another communication device 12-2 with a longer frequency division orthogonal cover code than that of the communication device 12-1 is co-scheduled with the communication device 12-1 in the same CDM group.

In some embodiments, the method further comprises, based on the signaling 20, determining which subcarriers contain DMRS from one or more other co-scheduled communication devices 12-1, 12-2 and estimating multi-user multiple-input multiple-output, MU-MIMO, interference.

In some embodiments, the method further comprises making the indicated assumption.

In some embodiments, the method further comprises receiving a data channel based on the signaling 20.

In some embodiments, the method further comprises determining a power offset between a data channel and a DMRS of the communication device 12-1 based on the signaling 20.

In some embodiments, the method further comprises determining rate matching for a data channel based on the signaling 20.

In some embodiments, the method further comprises, based on the signaling 20, determining in which resource elements to receive a data channel and/or in which resource elements to receive a DMRS.

In some embodiments, the method further comprises receiving a DMRS of the communication device 12-1 and processing the received DMRS based on the signaling 20.

In some embodiments, the communication device 12-1 is a 3GPP Release 18 user equipment.

In some embodiments, the method alternatively or additionally includes transmitting, to a network node 18 in the communication network 10, signaling 22 that indicates a demodulation reference signal, DMRS, capability of the communication device 12-1 (Block 800).

In some embodiments, the DMRS capability 24 includes support for co-scheduling DMRS for different communication devices 12-1, 12-2 with different numbers of code division multiplexing, CDM, groups.

In some embodiments, the DMRS capability 24 includes support for co-scheduling DMRS for different communication devices 12-1, 12-2 with different lengths of frequency-domain orthogonal cover codes, OCCs.

In some embodiments, the DMRS capability 24 includes support for the network node 18 to indicate, in physical layer control signaling 22, a DMRS type of a DMRS for a co-scheduled communication device 12-2.

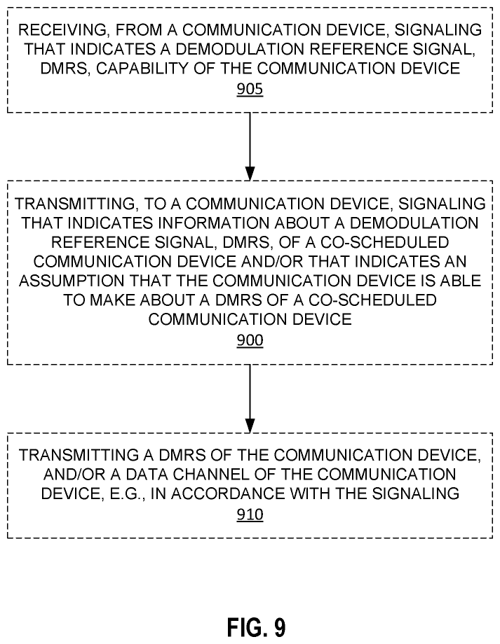

FIG. 9 depicts a method performed by a network node 18 configured for use in a communication network 10 in accordance with other particular embodiments. The method includes transmitting, to a communication device 12-1, 12-2, signaling 20 that indicates information about a demodulation reference signal, DMRS, of a co-scheduled communication device 12-2 and/or that indicates an assumption that the communication device 12-1 is able to make about a DMRS of a co-scheduled communication device 12-2 (Block 900).

In some embodiments, the method also includes transmitting a DMRS of the communication device 12-1, and/or a data channel of the communication device 12-1, e.g., in accordance with the signaling 20 (Block 910).

In some embodiments, the signaling 20 indicates information about a DMRS of a co-scheduled communication device 12-2.

In some embodiments, the information about a DMRS of a co-scheduled communication device 12-2 includes information as to whether or not a DMRS of a co-scheduled communication device 12-2 is of the same DMRS type as a DMRS of the communication device 12-1. In some embodiments, the information about a DMRS of a co-scheduled communication device 12-2 includes information indicating a DMRS type of the DMRS of the co-scheduled communication device 12-2. In some embodiments, the signaling 20 includes a bit field that explicitly indicates the DMRS type of the DMRS of the co-scheduled communication device 12-2. In some embodiments, the signaling 20 indicates an index of a code division multiplexing, CDM, group within which the DMRS of the co-scheduled communication device 12-2 is multiplexed. In this case, the index of the CDM group implicitly indicates the DMRS type of the DMRS of the co-scheduled communication device 12-2. In some embodiments, the information about a DMRS of a co-scheduled communication device 12-2 includes information as to whether or not a DMRS of a co-scheduled communication device 12-2 is multiplexed in the same code division multiplexing, CDM, group as a DMRS of the communication device 12-1. In other embodiments, the information about a DMRS of a co-scheduled communication device 12-2 includes information as to whether or not a DMRS of a co-scheduled communication device 12-2 is multiplexed in a code division multiplexing, CDM, group that has the same CDM group index as that of a CDM group of a DMRS of the communication device 12-1. In yet other embodiments, the information about a DMRS of a co-scheduled communication device 12-2 includes information indicating a CDM group or CDM group index of a DMRS of a co-scheduled communication device 12-2. In some embodiments, the information about a DMRS of a co-scheduled communication device 12-2 includes information as to whether or not a DMRS of a co-scheduled communication device 12-2 is multiplexed, in the same code division multiplexing, CDM, group as a DMRS of the communication device 12-1, using a longer frequency division orthogonal cover code, OCC, than a frequency division OCC with which a DMRS of the communication device 12-1 is multiplexed in the CDM group. In other embodiments, the information about a DMRS of a co-scheduled communication device 12-2 includes information indicating a length of a frequency division OCC with which a DMRS of a co-scheduled communication device 12-2 is multiplexed. In some embodiments, the signaling 20 is included in a physical layer control message that schedules a data channel for the communication device 12-1. In some embodiments, the physical layer control message is a Downlink Control Information, DCI, message.

In some embodiments, the signaling 20 indicates an assumption that the communication device 12-1 is able to make about a DMRS of a co-scheduled communication device 12-2. In some embodiments, the assumption is an assumption that a DMRS of a co-scheduled communication device 12-2 is, or is not, of the same DMRS type as a DMRS of the communication device 12-1. In some embodiments, the assumption is an assumption that a DMRS of a co-scheduled communication device 12-2 is able to be, or is not able to be, of the same DMRS type as a DMRS of the communication device 12-1. In some embodiments, the assumption is that, if a DMRS of the communication device 12-1 is a 3GPP Release 18 DMRS, a DMRS of a co-scheduled communication device 12-2 cannot be a 3GPP Release 15 DMRS. In some embodiments, the assumption is that if the communication device 12-1 is scheduled with a Rel-15 DMRS in Rel-15 CDM group 0, the communication device 12-1 does not expect that another communication device 12-2 is co-scheduled with a Rel-18 DMRS in Rel-18 CDM group 0 or Rel-18 CDM group 2. In other embodiments, the assumption is alternatively or additionally that if the communication device 12-1 is scheduled with a Rel-15 DMRS in Rel-15 CDM group 1, the communication device 12-1 does not expect that another communication device 12-2 is co-scheduled with a Rel-18 DMRS in Rel-18 CDM group 1 or Rel-18 CDM group 3. In yet other embodiments, the assumption is alternatively or additionally that if the communication device 12-1 is scheduled with a Rel-15 DMRS in Rel-15 CDM group 0, the communication device 12-1 does not expect Rel-18 DMRS being scheduled on DMRS resource elements, Res, for Rel-15 CDM group 1. In still yet other embodiments, the assumption is alternatively or additionally that if the communication device 12-1 is scheduled with a Rel-15 DMRS in Rel-15 CDM group 0, the communication device 12-1 does not expect to be co-scheduled with a Rel-18 DMRS in Rel-18 CDM group 1 or Rel-18 CDM group 3. In still yet other embodiments, the assumption is alternatively or additionally that if the communication device 12-1 is scheduled with a Rel-15 DMRS in Rel-15 CDM group 1, the communication device 12-1 does not expect Rel-18 DMRS being scheduled on the DMRS Res for Rel-15 CDM group 0. In still yet other embodiments, the assumption is alternatively or additionally that if the communication device 12-1 is scheduled with a Rel-15 DMRS in Rel-15 CDM group 1, the communication device 12-1 does not expect to be co-scheduled with a Rel-18 DMRS in Rel-18 CDM group 0 or Rel-18 CDM group 2. In some embodiments, the assumption is an assumption of a DMRS type of a DMRS of a co-scheduled communication device 12-2. In some embodiments, the signaling 20 is radio resource control, RRC, signaling 20. In some embodiments, the RRC signaling 20 includes a DMRS-DownlinkConfig information element that indicates the assumption that the communication device 12-1 is able to make.

In some embodiments, the signaling 20 also indicates whether or not another communication device 12-2 is co-scheduled with the communication device 12-1.

In some embodiments, the signaling 20 also indicates whether or not another communication device 12-2 is co-scheduled with the communication device 12-1 in the same code division multiplexing, CDM, group.

In some embodiments, the signaling 20 indicates whether or not another communication device 12-2 with a longer DMRS frequency division orthogonal cover code than that of the communication device 12-1 is co-scheduled with the communication device 12-1 in the same code division multiplexing, CDM, group.

In some embodiments, the method alternatively or additionally includes receiving, from a communication device 12-1, 12-2, signaling 22 that indicates a demodulation reference signal, DMRS, capability of the communication device 12-1 (Block 905).

In some embodiments, the DMRS capability 24 includes support for co-scheduling DMRS for different communication devices 12-1, 12-2 with different numbers of code division multiplexing, CDM, groups.

In some embodiments, the DMRS capability 24 includes support for co-scheduling DMRS for different communication devices 12-1, 12-2 with different lengths of frequency-domain orthogonal cover codes, OCCs.

In some embodiments, the DMRS capability 24 includes support for the network node 18 to indicate, in physical layer control signaling, a DMRS type of a DMRS for a co-scheduled communication device 12-2.

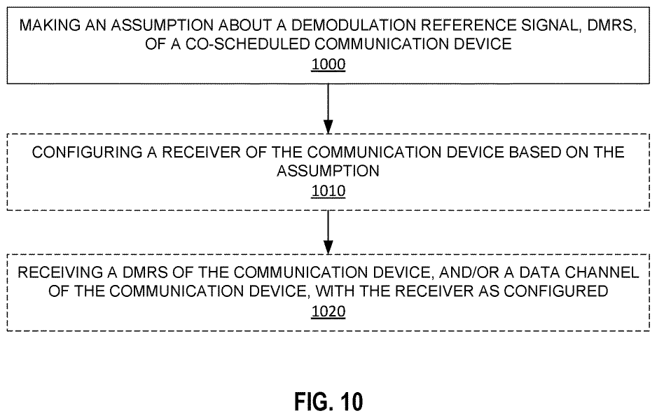

FIG. 10 depicts a method performed by a communication device 12-1, 12-2 configured for use in a communication network 10 in accordance with other particular embodiments. The method includes making an assumption about a demodulation reference signal, DMRS, of a co-scheduled communication device 12-2 (Block 1000).

In some embodiments, the method also includes configuring a receiver of the communication device 12-1 based on the assumption (Block 1010). In some embodiments, said configuring comprises configuring a length of a discrete cosign transform, DCT, window filter of the receiver. In some embodiments, the method further comprises receiving a DMRS of the communication device 12-1, and/or a data channel of the communication device 12-1, with the receiver as configured. In some embodiments, the assumption is that another communication device 12-2 is or is not co-scheduled with the communication device 12-1 in the same code division multiplexing, CDM, group, and said configuring comprises configuring the length of the DCT window filter to be shorter or longer depending respectively on whether or not another communication device 12-2 is co-scheduled with the communication device 12-1 in the same CDM group. In some embodiments, the assumption includes an assumption that another communication device 12-2 with a longer frequency division orthogonal cover code than that of the communication device 12-1 is or is not co-scheduled with the communication device 12-1 in the same code division multiplexing, CDM, group, and said configuring comprises configuring the length of the DCT window filter to be shorter or longer depending respectively on whether or not another communication device 12-2 with a longer frequency division orthogonal cover code than that of the communication device 12-1 is co-scheduled with the communication device 12-1 in the same CDM group.

In some embodiments, the method also includes receiving a DMRS of the communication device 12-1, and/or a data channel of the communication device 12-1, with the receiver as configured. (Block 1020).

In some embodiments, the assumption is an assumption that a DMRS of a co-scheduled communication device 12-2 is, or is not, of the same DMRS type as a DMRS of the communication device 12-1. In some embodiments, the assumption is an assumption that a DMRS of a co-scheduled communication device 12-2 is able to be, or is not able to be, of the same DMRS type as a DMRS of the communication device 12-1. In some embodiments, the assumption is that, if a DMRS of the communication device 12-1 is a 3GPP Release 18 DMRS, a DMRS of a co-scheduled communication device 12-2 cannot be a 3GPP Release 15 DMRS. In some embodiments, the assumption is that if the communication device 12-1 is scheduled with a Rel-15 DMRS in Rel-15 CDM group 0, the communication device 12-1 does not expect that another communication device 12-2 is co-scheduled with a Rel-18 DMRS in Rel-18 CDM group 0 or Rel-18 CDM group 2. In other embodiments, the assumption is alternatively or additionally that if the communication device 12-1 is scheduled with a Rel-15 DMRS in Rel-15 CDM group 1, the communication device 12-1 does not expect that another communication device 12-2 is co-scheduled with a Rel-18 DMRS in Rel-18 CDM group 1 or Rel-18 CDM group 3. In yet other embodiments, the assumption is alternatively or additionally that if the communication device 12-1 is scheduled with a Rel-15 DMRS in Rel-15 CDM group 0, the communication device 12-1 does not expect Rel-18 DMRS being scheduled on DMRS resource elements, Res, for Rel-15 CDM group 1. In still yet other embodiments, the assumption is alternatively or additionally that if the communication device 12-1 is scheduled with a Rel-15 DMRS in Rel-15 CDM group 0, the communication device 12-1 does not expect to be co-scheduled with a Rel-18 DMRS in Rel-18 CDM group 1 or Rel-18 CDM group 3. In still yet other embodiments, the assumption is alternatively or additionally that if the communication device 12-1 is scheduled with a Rel-15 DMRS in Rel-15 CDM group 1, the communication device 12-1 does not expect Rel-18 DMRS being scheduled on the DMRS REs for Rel-15 CDM group 0. In still yet other embodiments, the assumption is alternatively or additionally that if the communication device 12-1 is scheduled with a Rel-15 DMRS in Rel-15 CDM group 1, the communication device 12-1 does not expect to be co-scheduled with a Rel-18 DMRS in Rel-18 CDM group 0 or Rel-18 CDM group 2. In some embodiments, the assumption is an assumption of a DMRS type of a DMRS of a co-scheduled communication device 12-2. In some embodiments, the signaling 20 is radio resource control, RRC, signaling 20. In some embodiments, the RRC signaling 20 includes a DMRS-DownlinkConfig information element that indicates the assumption that the communication device 12-1 is able to make.

In some embodiments, the assumption includes an assumption of a DMRS type of a DMRS of a co-scheduled communication device 12-2.

In some embodiments, the method further comprises, based on the assumption, determining which subcarriers contain DMRS from one or more other co-scheduled communication devices 12-1, 12-2 and estimating multi-user multiple-input multiple-output, MU-MIMO, interference.

In some embodiments, the method further includes determining a power offset between a data channel and a DMRS of the communication device 12-1 based on the assumption.

In some embodiments, the method further includes determining rate matching for a data channel based on the assumption.

In some embodiments, the method further includes, based on the assumption, determining in which resource elements to receive a data channel and/or in which resource elements to receive a DMRS.

In some embodiments, the method further includes receiving a DMRS of the communication device 12-1 and processing the received DMRS based on the assumption.

In some embodiments, the communication device 12-1 supports a first DMRS type with a length M FD-OCC code and a second DMRS type with a length N FD-OCC code, where N>M, and the assumption is that, if the communication device 12-1 is scheduled with the first DMRS type, the communication device 12-1 does not expect to be co-scheduled with the second DMRS type in the same code division multiplexing, CDM, group.

In some embodiments, the communication device 12-1 is a 3GPP Release 18 communication device 12-1, 12-2 that supports both Release 18 DMRS and Release 15 DMRS, and the assumption is that, if the communication device 12-1 is scheduled with a Release 15 DMRS, the communication device 12-1 does not expect to be co-scheduled with a Release 18 DMRS in the same CDM group.

In some embodiments, the communication device 12-1 supports a first DMRS type with M CDM groups and a second DMRS type with N CDM groups, where M>N, and the assumption is that, if the communication device 12-1 is scheduled with the first DMRS type, the communication device 12-1 does not expect to be co-scheduled with the second DMRS type in another CDM group.

In some embodiments, the communication device 12-1 is a 3GPP Release 18 communication device 12-1, 12-2 that supports both Release 18 DMRS and Release 15 DMRS, and the assumption is that, if the communication device 12-1 is scheduled with a Release 18 DMRS, the communication device 12-1 does not expect to be co-scheduled with a Release 15 DMRS in another CDM group.

In some embodiments, the communication device 12-1 is a 3GPP Release 18 communication device 12-1, 12-2 that supports both Release 18 DMRS and Release 15 DMRS, and the assumption is that, if the communication device 12-1 receives an antenna port indication associated with X number of CDM groups without data, CDM groups without data are associated with a Release 18 DMRS.

In some embodiments, the communication device 12-1 is a 3GPP Release 18 user equipment.

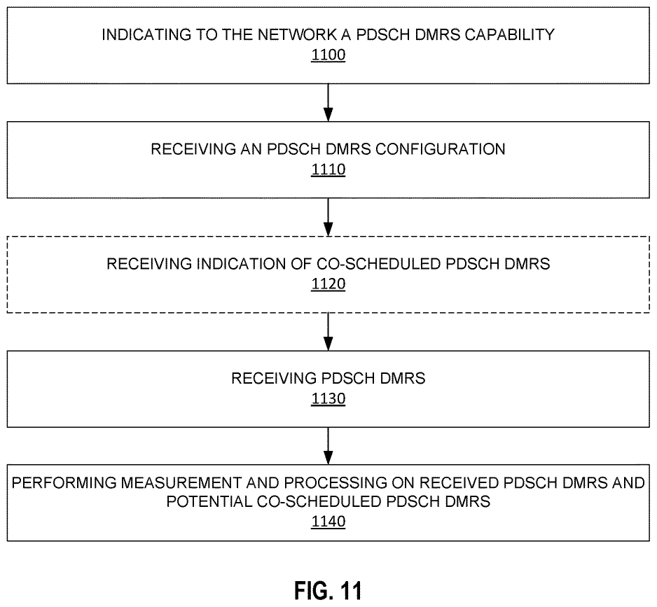

FIG. 11 depicts a method performed by a wireless device for PDSCH DMRS processing in accordance with other particular embodiments. The method includes indicating to the network a PDSCH DMRS capability (Block 1100) and receiving an PDSCH DMRS configuration (Block 1110).

In some embodiments, the method may include receiving indication of co-scheduled PDSCH DMRS (Block 1120).

Regardless, the method as shown also includes receiving PDSCH DMRS (Block 1130), and performing measurement and processing on received PDSCH DMRS and potential co-scheduled PDSCH DMRS (Block 1140).

In some embodiments, the PDSCH DMRS capability 24 includes at least support of co-scheduling PDSCH DMRS with different number of CDM groups. In other embodiments, the PDSCH DMRS capability 24 includes at least support of co-scheduling PDSCH DMRS with different FD-OCC lengths. In yet other embodiments, the PDSCH DMRS capability 24 includes at least support dynamic indication of DMRS type of co-scheduled PDSCH DMRS.

In some embodiments, when the UE receives the PDSCH DMRS, it assumes that other co-scheduled PDSCH DMRS belongs to the same type of DMRS as the one being received.

In some embodiments, when the UE receives the PDSCH DMRS, it assumes that other co-scheduled PDSCH DMRS belongs to a certain DMRS type. In some embodiments, the assumed co-scheduled DMRS type is the DMRS type with the same number of CDM groups but with longest FD-OCC codes. In some embodiments, the assumed co-scheduled DMRS type is the DMRS type with different number of CDM groups.

In some embodiments, the PDSCH DMRS configuration indicates what kind of DMRS type co-schedule UEs might have.

In some embodiments, the configuration could indicate co-scheduled UEs are using the same PDSCH DMRS type. In other embodiments, the configuration could indicate co-scheduled UEs are always using a certain DMRS type. In yet other embodiments, the configuration could indicate co-scheduled UEs might use either a first or a second DMRS type.

In some embodiments, the UE receives in the DCI scheduling the PDSCH DMRS, an indication whether the co-scheduled DMRS is of the same or different DMRS type.

In some embodiments, the UE adapts it receiver according to the PDSCH DMRS type of co-scheduled UEs.

In some embodiments, the UE scheduled with a DMRS design with short FD-OCC length is co-scheduled with a PDCH DMRS on the same CDM group with long FD-OCC length, adapts the time window filter of the DCT receiver accordingly (i.e., use a shorter time window).

In some embodiments, the indication of co-scheduled DMRS type is implicitly associated with index of CDM group. In some embodiments, UE assumes Rel-15 DMRS is always scheduled with CDM group of lower index, Rel-18 DMRS is scheduled with CDM group which maps to higher index of Rel-15 CDM group.

In some embodiments, power offset between PDSCH and DMRS is determined based on the indicated co-scheduled DMRS type (the power offset between DMRS and PDSCH can for example depend on the comb of a co-scheduled DMRS type, so depending on which comb that is used for the indicated co-scheduled DMRS type, the UE assumes a certain power offset between DMRS and PDSCH).

In some embodiments, the rate matching for the PDSCH is determined based on the indicated co-scheduled DMRS type (the rate matching of PDSCH can for example depend on the comb of the indicated co-scheduled DMRS type, so depending on which comb that is used for the indicated co-scheduled DMRS type, the UE assumes a certain rate matching of the PDSCH).

Embodiments herein also include corresponding apparatuses. Embodiments herein for instance include a communication device 12-1 configured to perform any of the steps of any of the embodiments described above for the communication device 12-1.

Embodiments also include a communication device 12-1 comprising processing circuitry and power supply circuitry. The processing circuitry is configured to perform any of the steps of any of the embodiments described above for the communication device 12-1. The power supply circuitry is configured to supply power to the communication device 12-1.

Embodiments further include a communication device 12-1 comprising processing circuitry. The processing circuitry is configured to perform any of the steps of any of the embodiments described above for the communication device 12-1. In some embodiments, the communication device 12-1 further comprises communication circuitry.

Embodiments further include a communication device 12-1 comprising processing circuitry and memory. The memory contains instructions executable by the processing circuitry whereby the communication device 12-1 is configured to perform any of the steps of any of the embodiments described above for the communication device 12-1.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12-1. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 18 configured to perform any of the steps of any of the embodiments described above for the network node 18.

Embodiments also include a network node 18 comprising processing circuitry and power supply circuitry. The processing circuitry is configured to perform any of the steps of any of the embodiments described above for the network node 18. The power supply circuitry is configured to supply power to the network node 18.

Embodiments further include a network node 18 comprising processing circuitry. The processing circuitry is configured to perform any of the steps of any of the embodiments described above for the network node 18. In some embodiments, the network node 18 further comprises communication circuitry.

Embodiments further include a network node 18 comprising processing circuitry and memory. The memory contains instructions executable by the processing circuitry whereby the network node 18 is configured to perform any of the steps of any of the embodiments described above for the network node 18.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

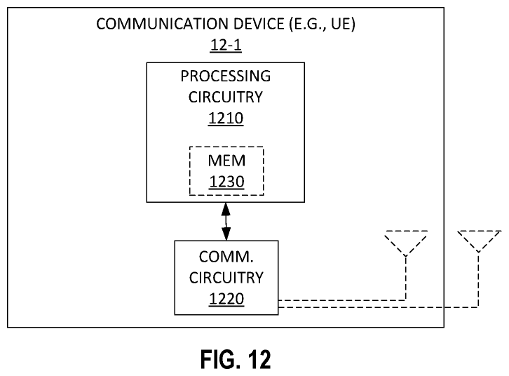

FIG. 12 for example illustrates a communication device 12-1 as implemented in accordance with one or more embodiments. As shown, the communication device 12-1 includes processing circuitry 1210 and communication circuitry 1220. The communication circuitry 1220 (e.g., radio circuitry) is configured to transmit and/or receive information to and/or from one or more other nodes, e.g., via any communication technology. Such communication may occur via one or more antennas that are either internal or external to the communication device 1200. The processing circuitry 1210 is configured to perform processing described above, e.g., in FIGS. 8 and/or 10, such as by executing instructions stored in memory 1230. The processing circuitry 1210 in this regard may implement certain functional means, units, or modules.

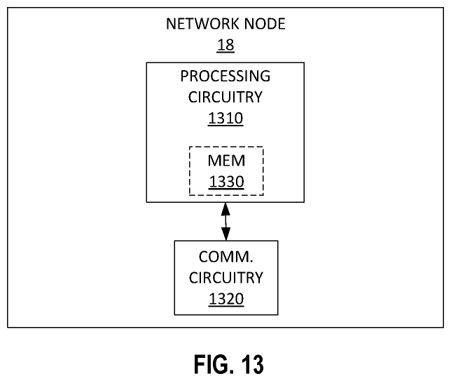

FIG. 13 illustrates a network node 18 as implemented in accordance with one or more embodiments. As shown, the network node 18 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 9, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

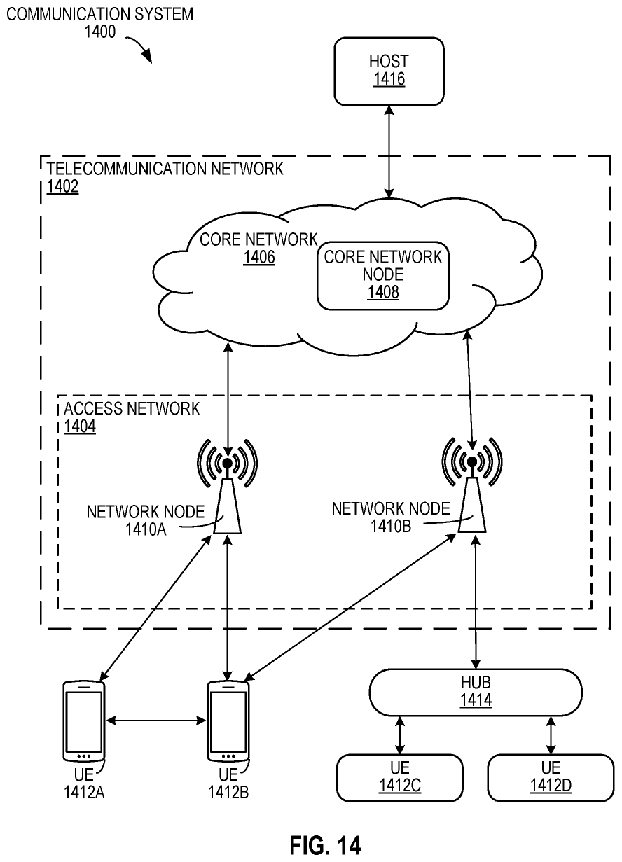

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

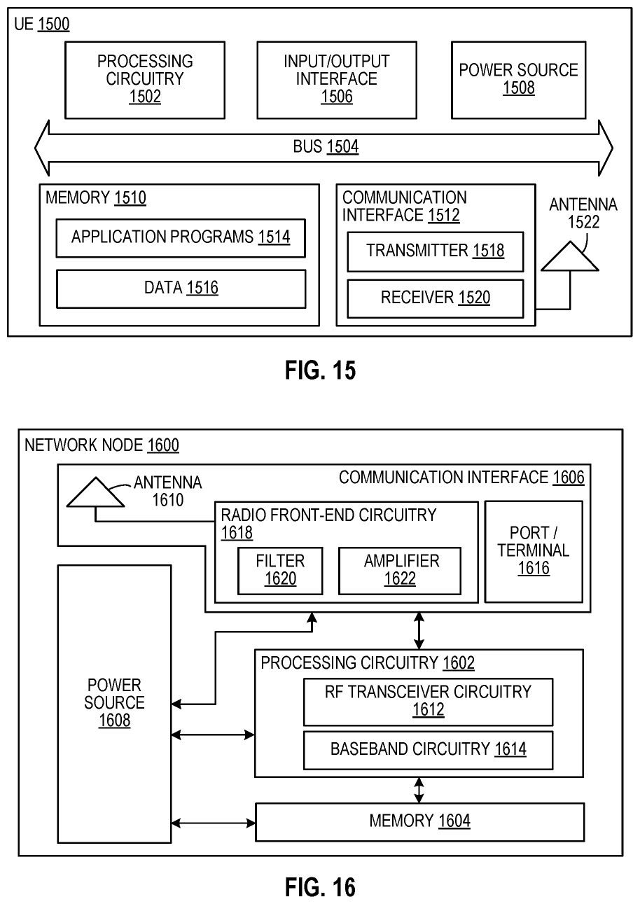

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

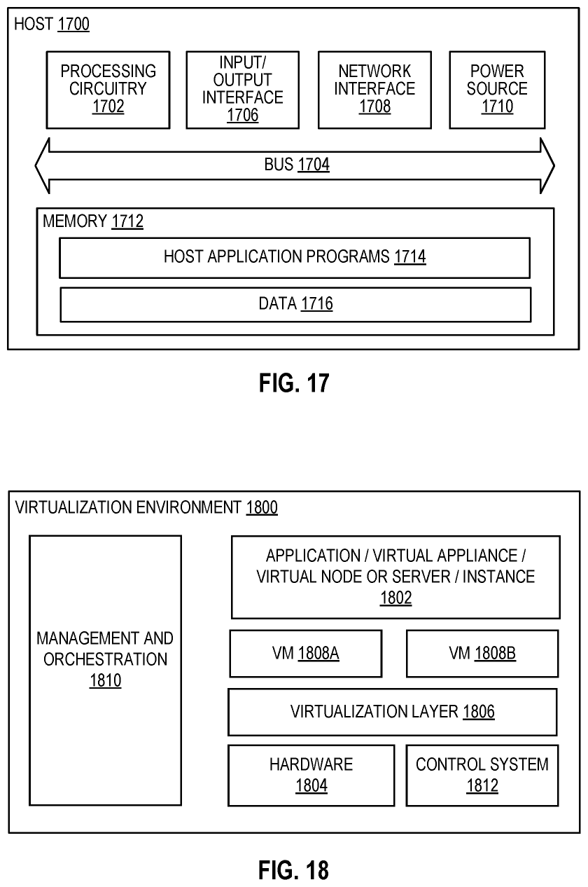

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE.

Embodiments of the host 1700 may utilize only a subset or all of the components shown. The host application programs 1714 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

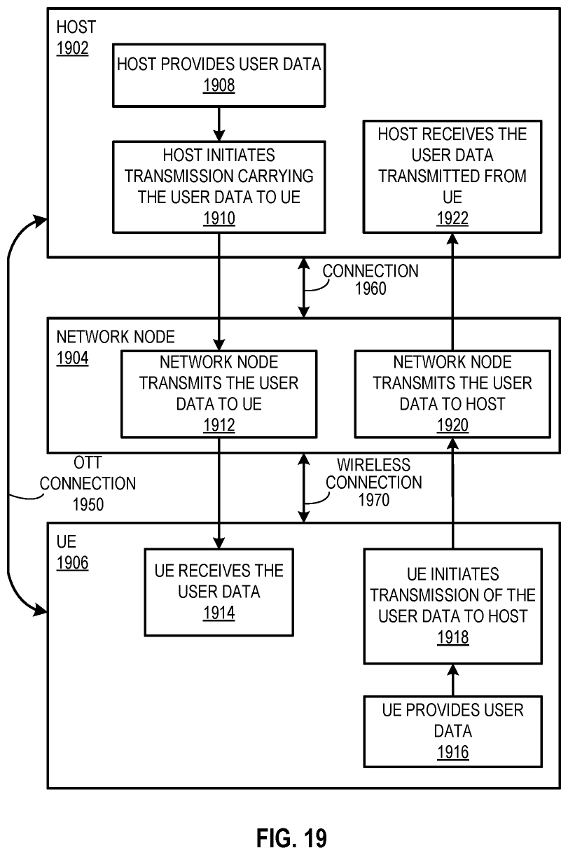

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally. Some embodiments herein are generally enumerated as below:

### Group A Embodiments

A1. A method performed by a communication device configured for use in a communication network, the method comprising:
receiving, from a network node in the communication network, signaling that indicates information about a demodulation reference signal, DMRS, of a co-scheduled communication device and/or that indicates an assumption that the communication device is able to make about a DMRS of a co-scheduled communication device.
   A2. The method of embodiment A1, wherein the signaling indicates information about a DMRS of a co-scheduled communication device.
   A3. The method of embodiment A2, wherein the information about a DMRS of a co-scheduled communication device includes information as to whether or not a DMRS of a co-scheduled communication device is of the same DMRS type as a DMRS of the communication device.
   A4. The method of any of embodiments A2-A3, wherein the information about a DMRS of a co-scheduled communication device includes information indicating a DMRS type of the DMRS of the co-scheduled communication device.
   A5. The method of embodiment A4, wherein the signaling includes a bit field that explicitly indicates the DMRS type of the DMRS of the co-scheduled communication device.
   A6. The method of embodiment A4, wherein the signaling indicates an index of a code division multiplexing, CDM, group within which the DMRS of the co-scheduled communication device is multiplexed, wherein the index of the CDM group implicitly indicates the DMRS type of the DMRS of the co-scheduled communication device.
   A7. The method of any of embodiments A2-A6, wherein the information about a DMRS of a co-scheduled communication device includes:
information as to whether or not a DMRS of a co-scheduled communication device is multiplexed in the same code division multiplexing, CDM, group as a DMRS of the communication device; or
information as to whether or not a DMRS of a co-scheduled communication device is multiplexed in a code division multiplexing, CDM, group that has the same CDM group index as that of a CDM group of a DMRS of the communication device; or
information indicating a CDM group or CDM group index of a DMRS of a co-scheduled communication device.
   A8. The method of any of embodiments A2-A7, wherein the information about a DMRS of a co-scheduled communication device includes:
information as to whether or not a DMRS of a co-scheduled communication device is multiplexed, in the same code division multiplexing, CDM, group as a DMRS of the communication device, using a longer frequency division orthogonal cover code, OCC, than a frequency division OCC with which a DMRS of the communication device is multiplexed in the CDM group; or
information indicating a length of a frequency division OCC with which a DMRS of a co-scheduled communication device is multiplexed.
   A9. The method of any of embodiments A2-A8, wherein the signaling is included in a physical layer control message that schedules a data channel for the communication device.
   A10. The method of embodiment A9, wherein the physical layer control message is a Downlink Control Information, DCI, message.
   A11. The method of any of embodiments A1-A10, wherein the signaling indicates an assumption that the communication device is able to make about a DMRS of a co-scheduled communication device.
   A12. The method of embodiment A11, wherein the assumption is an assumption that a DMRS of a co-scheduled communication device is, or is not, of the same DMRS type as a DMRS of the communication device.
   A13. The method of embodiment A11, wherein the assumption is an assumption that a DMRS of a co-scheduled communication device is able to be, or is not able to be, of the same DMRS type as a DMRS of the communication device.
   A14. The method of any of embodiments A11-A13, wherein the assumption is that, if a DMRS of the communication device is a 3GPP Release 18 DMRS, a DMRS of a co-scheduled communication device cannot be a 3GPP Release 15 DMRS.
   A15. The method of any of embodiments A11-A14, wherein the assumption is that:
if the communication device is scheduled with a Rel-15 DMRS in Rel-15 CDM group 0, the communication device does not expect that another communication device is co-scheduled with a Rel-18 DMRS in Rel-18 CDM group 0 or Rel-18 CDM group 2; and/or
if the communication device is scheduled with a Rel-15 DMRS in Rel-15 CDM group 1, the communication device does not expect that another communication device is co-scheduled with a Rel-18 DMRS in Rel-18 CDM group 1 or Rel-18 CDM group 3; and/or
if the communication device is scheduled with a Rel-15 DMRS in Rel-15 CDM group 0, the communication device does not expect Rel-18 DMRS being scheduled on DMRS resource elements, Res, for Rel-15 CDM group 1; and/or
if the communication device is scheduled with a Rel-15 DMRS in Rel-15 CDM group 0, the communication device does not expect to be co-scheduled with a Rel-18 DMRS in Rel-18 CDM group 1 or Rel-18 CDM group 3; and/or
if the communication device is scheduled with a Rel-15 DMRS in Rel-15 CDM group 1, the communication device does not expect Rel-18 DMRS being scheduled on the DMRS REs for Rel-15 CDM group 0; and/or
if the communication device is scheduled with a Rel-15 DMRS in Rel-15 CDM group 1, the communication device does not expect to be co-scheduled with a Rel-18 DMRS in Rel-18 CDM group 0 or Rel-18 CDM group 2.
   A16. The method of any of embodiments A11-A15, wherein the assumption is an assumption of a DMRS type of a DMRS of a co-scheduled communication device.
   A17. The method of any of embodiments A11-A16, wherein the signaling is radio resource control, RRC, signaling.
   A18. The method of embodiment A17, wherein the RRC signaling includes a DMRS-DownlinkConfig information element that indicates the assumption that the communication device is able to make.
   A19. The method of any of embodiments A1-A18, wherein the signaling also indicates whether or not another communication device is co-scheduled with the communication device.
   A20. The method of any of embodiments A1-A19, wherein the signaling also indicates whether or not another communication device is co-scheduled with the communication device in the same code division multiplexing, CDM, group.
   A21. The method of any of embodiments A1-A20, wherein the signaling indicates whether or not another communication device with a longer DMRS frequency division orthogonal cover code than that of the communication device is co-scheduled with the communication device in the same code division multiplexing, CDM, group.
   A22. The method of any of embodiments A1-A21, further comprising receiving a DMRS of the communication device, and/or a data channel of the communication device, based on the signaling.
   A23. The method of any of embodiments A1-A22, further comprising configuring a receiver of the communication device based on the signaling.
   A24. The method of embodiment A23, wherein said configuring comprises configuring a length of a discrete cosign transform, DCT, window filter of the receiver.
   A25. The method of any of embodiments A23-A24, further comprising receiving a DMRS of the communication device, and/or a data channel of the communication device, with the receiver as configured.
   A26. The method of any of embodiments A23-A25, wherein the signaling indicates whether or not another communication device is co-scheduled with the communication device in the same code division multiplexing, CDM, group, and wherein said configuring comprises configuring the length of the DCT window filter to be shorter or longer depending respectively on whether or not another communication device is co-scheduled with the communication device in the same CDM group.
   A27. The method of any of embodiments A23-A26, wherein the signaling indicates whether or not another communication device with a longer frequency division orthogonal cover code than that of the communication device is co-scheduled with the communication device in the same code division multiplexing, CDM, group, and wherein said configuring comprises configuring the length of the DCT window filter to be shorter or longer depending respectively on whether or not another communication device with a longer frequency division orthogonal cover code than that of the communication device is co-scheduled with the communication device in the same CDM group.
   A28. The method of any of embodiments A1-A27, further comprising, based on the signaling, determining which subcarriers contain DMRS from one or more other co-scheduled communication devices and estimating multi-user multiple-input multiple-output, MU-MIMO, interference.
   A29. The method of any of embodiments A1-A28, further comprising making the indicated assumption.
   A30. The method of any of embodiments A1-A29, further comprising receiving a data channel based on the signaling.
   A31. The method of any of embodiments A1-A30, further comprising determining a power offset between a data channel and a DMRS of the communication device based on the signaling.
   A32. The method of any of embodiments A1-A31, further comprising determining rate matching for a data channel based on the signaling.
   A33. The method of any of embodiments A1-A32, further comprising, based on the signaling, determining in which resource elements to receive a data channel and/or in which resource elements to receive a DMRS.
   A34. The method of any of embodiments A1-A33, further comprising receiving a DMRS of the communication device and processing the received DMRS based on the signaling.
   A35. The method of any of embodiments A1-A34, wherein the communication device is a 3GPP Release 18 user equipment.
   AA1. A method performed by a communication device configured for use in a communication network, the method comprising:
transmitting, to a network node in the communication network, signaling that indicates a demodulation reference signal, DMRS, capability of the communication device.
   AA2. The method of embodiment AA1, wherein the DMRS capability includes support for co-scheduling DMRS for different communication devices with different numbers of code division multiplexing, CDM, groups.
   AA3. The method of any of embodiments AA1-AA2, wherein the DMRS capability includes support for co-scheduling DMRS for different communication devices with different lengths of frequency-domain orthogonal cover codes, OCCs.
   AA4. The method of any of embodiments AA1-AA3, wherein the DMRS capability includes support for the network node to indicate, in physical layer control signaling, a DMRS type of a DMRS for a co-scheduled communication device.
   AA5. The method of any of embodiments AA1-AA4, further comprising any one or more of the steps of any of embodiments A1-A33.
   AAA1. A method performed by a communication device configured for use in a communication network, the method comprising:
making an assumption about a demodulation reference signal, DMRS, of a co-scheduled communication device.
   AAA2. The method of embodiment AAA1, wherein the assumption includes an assumption that a DMRS of a co-scheduled communication device is, or is not, of the same DMRS type as a DMRS of the communication device.
   AAA3. The method of any of embodiments AAA1-AAA2, wherein the assumption includes an assumption that a DMRS of a co-scheduled communication device is able to be, or is not able to be, of the same DMRS type as a DMRS of the communication device.
   AAA4. The method of any of embodiments AAA1-AAA2, wherein the assumption includes an assumption that, if a DMRS of the communication device is a 3GPP Release 18 DMRS, a DMRS of a co-scheduled communication device cannot be a 3GPP Release 15 DMRS.
   AAA5. The method of any of embodiments AAA1-AAA4, wherein the assumption includes an assumption that:
if the communication device is scheduled with a Rel-15 DMRS in Rel-15 CDM group 0, the communication device does not expect that another communication device is co-scheduled with a Rel-18 DMRS in Rel-18 CDM group 0 or Rel-18 CDM group 2; and/or
if the communication device is scheduled with a Rel-15 DMRS in Rel-15 CDM group 1, the communication device does not expect that another communication device is co-scheduled with a Rel-18 DMRS in Rel-18 CDM group 1 or Rel-18 CDM group 3; and/or
if the communication device is scheduled with a Rel-15 DMRS in Rel-15 CDM group 0, the communication device does not expect Rel-18 DMRS being scheduled on DMRS resource elements, Res, for Rel-15 CDM group 1; and/or
if the communication device is scheduled with a Rel-15 DMRS in Rel-15 CDM group 0, the communication device does not expect to be co-scheduled with a Rel-18 DMRS in Rel-18 CDM group 1 or Rel-18 CDM group 3;
if the communication device is scheduled with a Rel-15 DMRS in Rel-15 CDM group 1, the communication device does not expect Rel-18 DMRS being scheduled on the DMRS REs for Rel-15 CDM group 0; and/or
if the communication device is scheduled with a Rel-15 DMRS in Rel-15 CDM group 1, the communication device does not expect to be co-scheduled with a Rel-18 DMRS in Rel-18 CDM group 0 or Rel-18 CDM group 2.
   AAA6. The method of any of embodiments AA1-AAA5, the assumption include an assumption of a DMRS type of a DMRS of a co-scheduled communication device.
   AAA7. The method of any of embodiments AAA1-AAA6, further comprising receiving a DMRS of the communication device, and/or a data channel of the communication device, based on the assumption.
   AAA8. The method of any of embodiments AAA1-AAA7, further comprising configuring a receiver of the communication device based on the assumption.
   AAA9. The method of embodiment AAA8, wherein said configuring comprises configuring a length of a discrete cosign transform, DCT, window filter of the receiver.
   AAA10. The method of any of embodiments AAA8-AAA9, further comprising receiving a DMRS of the communication device, and/or a data channel of the communication device, with the receiver as configured.
   AAA11. The method of any of embodiments AAA8-AAA10, wherein the assumption is that another communication device is or is not co-scheduled with the communication device in the same code division multiplexing, CDM, group, and wherein said configuring comprises configuring the length of the DCT window filter to be shorter or longer depending respectively on whether or not another communication device is assumed to be co-scheduled with the communication device in the same CDM group.
   AAA12. The method of any of embodiments AAA8-AAA11, wherein the assumption includes an assumption that another communication device with a longer frequency division orthogonal cover code than that of the communication device is or is not co-scheduled with the communication device in the same code division multiplexing, CDM, group, and wherein said configuring comprises configuring the length of the DCT window filter to be shorter or longer depending respectively on whether or not another communication device with a longer frequency division orthogonal cover code than that of the communication device is or is not assumed to be co-scheduled with the communication device in the same CDM group.
   AAA13. The method of any of embodiments AAA1-AAA12, further comprising, based on the assumption, determining which subcarriers contain DMRS from one or more other co-scheduled communication devices and estimating multi-user multiple-input multiple-output, MU-MIMO, interference.
   AAA14. The method of any of embodiments AAA1-AAA13, further comprising receiving a data channel based on the assumption.
   AAA15. The method of any of embodiments AAA1-AAA14, further comprising determining a power offset between a data channel and a DMRS of the communication device based on the assumption.
   AAA16. The method of any of embodiments AAA1-AAA15, further comprising determining rate matching for a data channel based on the assumption.
   AAA17. The method of any of embodiments AAA1-AAA16, further comprising, based on the assumption, determining in which resource elements to receive a data channel and/or in which resource elements to receive a DMRS.
   AAA18. The method of any of embodiments AAA1-AAA17, further comprising receiving a DMRS of the communication device and processing the received DMRS based on the assumption.
   AAA19. The method of any of embodiments AAA1-AAA18, wherein the communication device supports a first DMRS type with a length M FD-OCC code and a second DMRS type with a length N FD-OCC code, where N>M, and wherein the assumption is that, if the communication device is scheduled with the first DMRS type, the communication device does not expect to be co-scheduled with the second DMRS type in the same code division multiplexing, CDM, group.
   AAA20. The method of any of embodiments AAA1-AAA18, wherein the communication device is a 3GPP Release 18 communication device that supports both Release 18 DMRS and Release 15 DMRS, and wherein the assumption is that, if the communication device is scheduled with a Release 15 DMRS, the communication device does not expect to be co-scheduled with a Release 18 DMRS in the same CDM group.
   AAA21. The method of any of embodiments AAA1-AAA20, wherein the communication device supports a first DMRS type with M CDM groups and a second DMRS type with N CDM groups, where M>N, and wherein the assumption is that, if the communication device is scheduled with the first DMRS type, the communication device does not expect to be co-scheduled with the second DMRS type in another CDM group.
   AAA22. The method of any of embodiments AAA1-AAA21, wherein the communication device is a 3GPP Release 18 communication device that supports both Release 18 DMRS and Release 15 DMRS, and wherein the assumption is that, if the communication device is scheduled with a Release 18 DMRS, the communication device does not expect to be co-scheduled with a Release 15 DMRS in another CDM group.
   AAA23. The method of any of embodiments AAA1-AAA22, wherein the communication device is a 3GPP Release 18 communication device that supports both Release 18 DMRS and
   Release 15 DMRS, and wherein the assumption is that, if the communication device receives an antenna port indication associated with X number of CDM groups without data, CDM groups without data are associated with a Release 18 DMRS.
   AAA24. The method of any of embodiments AAA1-AAA23, wherein the communication device is a 3GPP Release 18 user equipment.
   AA. The method of any of the previous embodiments, further comprising:
providing user data; and forwarding the user data to a host computer via the transmission to a base station.

### Group B Embodiments

B1. A method performed by a network node configured for use in a communication network, the method comprising:
transmitting, to a communication device, signaling that indicates information about a demodulation reference signal, DMRS, of a co-scheduled communication device and/or that indicates an assumption that the communication device is able to make about a DMRS of a co-scheduled communication device.
   B2. The method of embodiment B1, wherein the signaling indicates information about a DMRS of a co-scheduled communication device.
   B3. The method of embodiment B2, wherein the information about a DMRS of a co-scheduled communication device includes information as to whether or not a DMRS of a co-scheduled communication device is of the same DMRS type as a DMRS of the communication device.
   B4. The method of any of embodiments B2-B3, wherein the information about a DMRS of a co-scheduled communication device includes information indicating a DMRS type of the DMRS of the co-scheduled communication device.
   B5. The method of embodiment B4, wherein the signaling includes a bit field that explicitly indicates the DMRS type of the DMRS of the co-scheduled communication device.
   B6. The method of embodiment B4, wherein the signaling indicates an index of a code division multiplexing, CDM, group within which the DMRS of the co-scheduled communication device is multiplexed, wherein the index of the CDM group implicitly indicates the DMRS type of the DMRS of the co-scheduled communication device.
   B7. The method of any of embodiments B2-B6, wherein the information about a DMRS of a co-scheduled communication device includes:
information as to whether or not a DMRS of a co-scheduled communication device is multiplexed in the same code division multiplexing, CDM, group as a DMRS of the communication device; or
information as to whether or not a DMRS of a co-scheduled communication device is multiplexed in a code division multiplexing, CDM, group that has the same CDM group index as that of a CDM group of a DMRS of the communication device; or
information indicating a CDM group or CDM group index of a DMRS of a co-scheduled communication device.
   B8. The method of any of embodiments B2-B7, wherein the information about a DMRS of a co-scheduled communication device includes:
information as to whether or not a DMRS of a co-scheduled communication device is multiplexed, in the same code division multiplexing, CDM, group as a DMRS of the communication device, using a longer frequency division orthogonal cover code, OCC, than a frequency division OCC with which a DMRS of the communication device is multiplexed in the CDM group; or
information indicating a length of a frequency division OCC with which a DMRS of a co-scheduled communication device is multiplexed.
   B9. The method of any of embodiments B2-B8, wherein the signaling is included in a physical layer control message that schedules a data channel for the communication device.
   B10. The method of embodiment B9, wherein the physical layer control message is a Downlink Control Information, DCI, message.
   B11. The method of any of embodiments B1-B10, wherein the signaling indicates an assumption that the communication device is able to make about a DMRS of a co-scheduled communication device.
   B12. The method of embodiment B11, wherein the assumption is an assumption that a DMRS of a co-scheduled communication device is, or is not, of the same DMRS type as a DMRS of the communication device.
   B13. The method of embodiment B11, wherein the assumption is an assumption that a DMRS of a co-scheduled communication device is able to be, or is not able to be, of the same DMRS type as a DMRS of the communication device.
   B14. The method of any of embodiments B11-B13, wherein the assumption is that, if a DMRS of the communication device is a 3GPP Release 18 DMRS, a DMRS of a co-scheduled communication device cannot be a 3GPP Release 15 DMRS.
   B15. The method of any of embodiments B11-B14, wherein the assumption is that:
if the communication device is scheduled with a Rel-15 DMRS in Rel-15 CDM group 0, the communication device does not expect that another communication device is co-scheduled with a Rel-18 DMRS in Rel-18 CDM group 0 or Rel-18 CDM group 2; and/or
if the communication device is scheduled with a Rel-15 DMRS in Rel-15 CDM group 1, the communication device does not expect that another communication device is co-scheduled with a Rel-18 DMRS in Rel-18 CDM group 1 or Rel-18 CDM group 3; and/or
if the communication device is scheduled with a Rel-15 DMRS in Rel-15 CDM group 0, the communication device does not expect Rel-18 DMRS being scheduled on DMRS resource elements, Res, for Rel-15 CDM group 1; and/or
if the communication device is scheduled with a Rel-15 DMRS in Rel-15 CDM group 0, the communication device does not expect to be co-scheduled with a Rel-18 DMRS in Rel-18 CDM group 1 or Rel-18 CDM group 3; and/or
if the communication device is scheduled with a Rel-15 DMRS in Rel-15 CDM group 1, the communication device does not expect Rel-18 DMRS being scheduled on the DMRS REs for Rel-15 CDM group 0; and/or
if the communication device is scheduled with a Rel-15 DMRS in Rel-15 CDM group 1, the communication device does not expect to be co-scheduled with a Rel-18 DMRS in Rel-18 CDM group 0 or Rel-18 CDM group 2.
   B16. The method of any of embodiments B11-B15, wherein the assumption is an assumption of a DMRS type of a DMRS of a co-scheduled communication device.
   B17. The method of any of embodiments B11-B16, wherein the signaling is radio resource control, RRC, signaling.
   B18. The method of embodiment B17, wherein the RRC signaling includes a DMRS-DownlinkConfig information element that indicates the assumption that the communication device is able to make.
   B19. The method of any of embodiments B1-B18, wherein the signaling also indicates whether or not another communication device is co-scheduled with the communication device.
   B20. The method of any of embodiments B1-B19, wherein the signaling also indicates whether or not another communication device is co-scheduled with the communication device in the same code division multiplexing, CDM, group.
   B21. The method of any of embodiments B1-B20, wherein the signaling indicates whether or not another communication device with a longer DMRS frequency division orthogonal cover code than that of the communication device is co-scheduled with the communication device in the same code division multiplexing, CDM, group.
   B22. The method of any of embodiments B1-B21, further comprising transmitting a DMRS of the communication device, and/or a data channel of the communication device, in accordance with the signaling.
   BB. The method of any of the previous embodiments, further comprising:
obtaining user data; and forwarding the user data to a host computer or a communication device.

### Group Z Embodiments

The following embodiments are applicable for both NR Rel-18 and for 6G. In the following embodiments, PDSCH is used; however, the embodiments are extendable to PUSCH or another type of data channel, e.g., specified in 6G.

In the following embodiments, the term DMRS type is used. Two DMRSs are assumed to belong to the same DMRS type in case they have the same number of CDM groups (i.e. same comb structure/sub-carrier allocation structure) and the same length of the FD-OCC code.

For example, in NR after Rel-18 (for DMRS Type 1), there might be two different DMRS types, the legacy DMRS type 1 (with comb 2) and a new extended Rel-18 DMRS type 1 with comb 4.

In 6G, for example, there might be one new DMRS design that consist of two DMRS types (e.g. a first DMRS type with comb 2 and a second DMRS type with comb 4), such that a 6G UE supporting the new DMRS design dynamically can be scheduled with either comb 2 or comb 4 DMRS, in order to balance the DMRS performance vs DMRS capacity.

Z1. A method in a wireless device for PDSCH DMRS processing, the method comprising:
indicating to the network a PDSCH DMRS capability;
receiving an PDSCH DMRS configuration;
(optional) receiving indication of co-scheduled PDSCH DMRS;
receiving PDSCH DMRS; and
performing measurement and processing on received PDSCH DMRS and potential co-scheduled PDSCH DMRS.
   Z2. The method of embodiment Z1, wherein the PDSCH DMRS capability includes one or more of:
support of co-scheduling PDSCH DMRS with different number of CDM groups;
support of co-scheduling PDSCH DMRS with different FD-OCC lengths; and
support dynamic indication of DMRS type of co-scheduled PDSCH DMRS.
   Z3. The method of embodiment Z1, wherein when the UE receives the PDSCH DMRS, it assumes that other co-scheduled PDSCH DMRS belongs to the same type of DMRS as the one being received.
   Z4. The method of embodiment Z1, wherein when the UE receives the PDSCH DMRS, it assumes that other co-scheduled PDSCH DMRS belongs to a certain DMRS type.
   Z5. The method of embodiment Z4, wherein the assumed co-scheduled DMRS type is the DMRS type with the same number of CDM groups but with longest FD-OCC codes.
   Z6. The method of embodiment Z4, wherein the assumed co-scheduled DMRS type is the DMRS type with different number of CDM groups.
   Z7. The method of embodiment Z1, wherein the PDSCH DMRS configuration indicates what kind of DMRS type co-schedule UEs might have.
   Z8. The method of embodiment Z6, wherein the configuration could indicate:
co-scheduled UEs are using the same PDSCH DMRS type;
co-scheduled UEs are always using a certain DMRS type; or
co-scheduled UEs might use either a first or a second DMRS type.
   Z9. The method of embodiment Z1, wherein the UE receives in the DCI scheduling the PDSCH DMRS, an indication whether the co-scheduled DMRS is of the same or different DMRS type.
   Z10. The method of embodiment Z1, wherein the UE adapts it receiver according to the PDSCH DMRS type of co-scheduled UEs.
   Z11. The method of embodiment Z9, wherein the UE scheduled with a DMRS design with short FD-OCC length is co-scheduled with a PDCH DMRS on the same CDM group with long FD-OCC length, adapts the time window filter of the DCT receiver accordingly (i.e., use a shorter time window).
   Z12. The method of embodiment Z1, wherein the indication of co-scheduled DMRS type is implicitly associated with index of CDM group, wherein UE assumes Rel-15 DMRS is always scheduled with CDM group of lower index, Rel-18 DMRS is scheduled with CDM group which maps to higher index of Rel-15 CDM group.
   Z13. The method of embodiment Z1, wherein power offset between PDSCH and DMRS is determined based on the indicated co-scheduled DMRS type (the power offset between DMRS and PDSCH can for example depend on the comb of a co-scheduled DMRS type, so depending on which comb that is used for the indicated co-scheduled DMRS type, the UE assumes a certain power offset between DMRS and PDSCH).
   Z14. The method of embodiment Z1, wherein the rate matching for the PDSCH is determined based on the indicated co-scheduled DMRS type (the rate matching of PDSCH can for example depend on the comb of the indicated co-scheduled DMRS type, so depending on which comb that is used for the indicated co-scheduled DMRS type, the UE assumes a certain rate matching of the PDSCH).

### Group C Embodiments

C1. A communication device configured to perform any of the steps of any of the Group A or Group Z embodiments.
C2. A communication device comprising processing circuitry configured to perform any of the steps of any of the Group A or Group Z embodiments.
C3. A communication device comprising:
communication circuitry; and
processing circuitry configured to perform any of the steps of any of the Group A or Group Z embodiments.
   C4. A communication device comprising:
processing circuitry configured to perform any of the steps of any of the Group A or Group Z embodiments; and
power supply circuitry configured to supply power to the communication device.
   C5. A communication device comprising:
processing circuitry and memory, the memory containing instructions executable by the processing circuitry whereby the communication device is configured to perform any of the steps of any of the Group A or Group Z embodiments.
   C6. The communication device of any of embodiments C1-C5, wherein the communication device is a wireless communication device.
   C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A or Group Z embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C8. A computer program comprising instructions which, when executed by at least one processor of a communication device, causes the communication device to carry out the steps of any of the Group A or Group Z embodiments.
   C9. A carrier containing the computer program of embodiment C7, wherein the carrier is one of an electronic signal, optical signal, radio signal, or computer readable storage medium.
   C10. A network node configured to perform any of the steps of any of the Group B embodiments.
   C11. A network node comprising processing circuitry configured to perform any of the steps of any of the Group B embodiments.
   C12. A network node comprising:
communication circuitry; and
processing circuitry configured to perform any of the steps of any of the Group B embodiments.
   C13. A network node comprising:
processing circuitry configured to perform any of the steps of any of the Group B embodiments;
power supply circuitry configured to supply power to the network node.
   C14. A network node comprising:
processing circuitry and memory, the memory containing instructions executable by the processing circuitry whereby the network node is configured to perform any of the steps of any of the Group B embodiments.
   C15. The network node of any of embodiments C10-C14, wherein the network node is a base station.
   C16. A computer program comprising instructions which, when executed by at least one processor of a network node, causes the network node to carry out the steps of any of the Group B embodiments.
   C17. The computer program of embodiment C16, wherein the network node is a base station.
   C18. A carrier containing the computer program of any of embodiments C16-C17, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A or Group Z embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A or Group Z embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A or Group Z embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A or Group Z embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:

at the host computer, receiving, from the base station, user data originating from a transmission which the base station has received from the UE, wherein the UE performs any of the steps of any of the Group A or Group Z embodiments.

D28. The method of the previous embodiment, further comprising at the base station, receiving the user data from the UE.

D29. The method of the previous 2 embodiments, further comprising at the base station, initiating a transmission of the received user data to the host computer.

1.-38. (canceled)

39. A method performed by a communication device configured for use in a communication network, the method comprising:
receiving, from a network node, radio resource control (RRC) signaling that indicates the communication device is able to make an assumption about whether any demodulation reference signal (DMRS) co-scheduled for a different communication device is of a different type than the DMRS for the communication device, wherein the communication device is a 3GPP Release 18 communication device that supports both Release 18 DMRS and Release 15 DMRS, and wherein the assumption is that, if the communication device is scheduled with a Release 15 DMRS, the communication device does not expect to be co-scheduled with a Release 18 DMRS in the same code division multiplexing (CDM) group;
making the assumption based on the received RRC signaling; and
receiving a DMRS and/or a data channel for the communication device from the network node based on the assumption.

40. The method of claim 39, wherein DMRSs of different types include DMRSs associated with different lengths of frequency-domain orthogonal cover codes, (OCCs).

41. The method of claim 39, wherein DMRSs of different types include DMRSs multiplexed over different numbers of code division multiplexing (CDM) groups.

42. The method of claim 39, further comprising transmitting, to the network node in the communication network, signaling that indicates a DMRS capability of the communication device, wherein the DMRS capability includes support for the communication network co-scheduling DMRSs of different types for different communication devices.

43. The method of any of claim 42, wherein the DMRS capability includes support for the communication network co-scheduling a 3GPP Release 18 DMRS and a 3GPP Release 15 DMRS for different communication devices.

44. The method of claim 39, wherein according to the assumption the communication device does not expect the communication network to co-schedule DMRSs of different types for different communication devices.

45. The method of claim 39, wherein receiving the DMRS and/or a data channel for the communication device based on the assumption comprises:
configuring a length of a discrete cosign transform (DCT) window filter of a receiver of the communication device based on the assumption and receiving the DMRS and/or the data channel for the communication device with the receiver as configured;
based on the assumption, determining which subcarriers contain DMRS from one or more other co-scheduled communication devices and estimating multi-user multiple-input multiple-output (MU-MIMO) interference based on the determined subcarriers;
determining a power offset between the data channel and the DMRS for the communication device based on the assumption;
determining rate matching for the data channel based on the assumption; and/or
based on the assumption, determining in which resource elements to receive the data channel and/or in which resource elements to receive the DMRS for the communication device.

46. A method performed by a network node configured for use in a communication network, the method comprising:
transmitting a demodulation reference signal (DMRS) and/or a data channel for a communication device from the network node; and
transmitting, to the communication device, radio resource control (RRC) signaling indicating an assumption that the communication device is able to make about whether any DMRS co-scheduled for a different communication device is of a different type than the DMRS for the communication device,
wherein the communication device is a 3GPP Release 18 communication device that supports both Release 18 DMRS and Release 15 DMRS, and wherein the RRC signaling indicates that, if the communication device is scheduled with a Release 15 DMRS, the communication device is able to assume that the communication device is not co-scheduled with a Release 18 DMRS in the same code division multiplexing (CDM) group.

47. The method of claim 46, wherein DMRSs of different types include DMRSs associated with different lengths of frequency-domain orthogonal cover codes (OCCs).

48. The method of claim 46, wherein DMRSs of different types include DMRSs multiplexed over different numbers of code division multiplexing (CDM) groups.

49. The method of claim 46, further comprising receiving, from the communication device, signaling that indicates a DMRS capability of the communication device, wherein the DMRS capability includes support for the communication network co-scheduling DMRSs of different types for different communication devices.

50. The method of claim 49, wherein the DMRS capability includes support for the communication network co-scheduling a 3GPP Release 18 DMRS and a 3GPP Release 15 DMRS for different communication devices.

51. A communication device configured for use in a communication network, the communication device comprising:
communication circuitry; and
processing circuitry configured to:
receive, from a network node, radio resource control (RRC) signaling that indicates the communication device is able to make an assumption about whether any demodulation reference signal (DMRS) co-scheduled for a different communication device is of a different type than the DMRS for the communication device, wherein the communication device is a 3GPP Release 18 communication device that supports both Release 18 DMRS and Release 15 DMRS, and wherein the assumption is that, if the communication device is scheduled with a Release 15 DMRS, the communication device does not expect to be co-scheduled with a Release 18 DMRS in the same code division multiplexing (CDM) group;
make the assumption based on the received RRC signaling; and
receive a DMRS and/or a data channel for the communication device from the network node based on the assumption.

52. The communication device of claim 51, wherein DMRSs of different types include DMRSs associated with different lengths of frequency-domain orthogonal cover codes, (OCCs).

53. The communication device of claim 51, wherein DMRSs of different types include DMRSs multiplexed over different numbers of code division multiplexing (CDM) groups.

54. The communication device of claim 51, wherein the processing circuitry is further configured to transmit, to the network node in the communication network, signaling that indicates a DMRS capability of the communication device, wherein the DMRS capability includes support for the communication network co-scheduling DMRSs of different types for different communication devices.

55. The communication device of claim 54, wherein the DMRS capability includes support for the communication network co-scheduling a 3GPP Release 18 DMRS and a 3GPP Release 15 DMRS for different communication devices.

56. The communication device of claim 51, wherein according to the assumption the communication device does not expect the communication network to co-schedule DMRSs of different types for different communication devices.

57. The communication device of claim 51, wherein the processing circuitry is configured to:
configure a length of a discrete cosign transform (DCT) window filter of a receiver of the communication device based on the assumption and receive the DMRS and/or the data channel for the communication device with the receiver as configured;
based on the assumption, determine which subcarriers contain DMRS from one or more other co-scheduled communication devices and estimate multi-user multiple-input multiple-output (MU-MIMO) interference based on the determined subcarriers;
determine a power offset between the data channel and the DMRS for the communication device based on the assumption;
determine rate matching for the data channel based on the assumption; and/or
based on the assumption, determine in which resource elements to receive the data channel and/or in which resource elements to receive the DMRS for the communication device.

58. A network node configured for use in a communication network, the network node comprising:
communication circuitry; and
processing circuitry configured to:
transmit a demodulation reference signal (DMRS) and/or a data channel for a communication device from the network node; and
transmit, to the communication device, radio resource control (RRC) signaling indicating an assumption that the communication device is able to make about whether any DMRS co-scheduled for a different communication device is of a different type than the DMRS for the communication device,
wherein the communication device is a 3GPP Release 18 communication device that supports both Release 18 DMRS and Release 15 DMRS, and wherein the RRC signaling indicates that, if the communication device is scheduled with a Release 15 DMRS, the communication device is able to assume that the communication device is not co-scheduled with a Release 18 DMRS in the same code division multiplexing (CDM) group.

59. The network node of claim 58, wherein DMRSs of different types include DMRSs associated with different lengths of frequency-domain orthogonal cover codes (OCCs).

60. The network node of claim 58, wherein DMRSs of different types include DMRSs multiplexed over different numbers of code division multiplexing (CDM) groups.

61. The network node of claim 58, wherein the processing circuitry is further configured to receive, from the communication device, signaling that indicates a DMRS capability of the communication device, wherein the DMRS capability includes support for the communication network co-scheduling DMRSs of different types for different communication devices.

62. The network node of claim 69, wherein the DMRS capability includes support for the communication network co-scheduling a 3GPP Release 18 DMRS and a 3GPP Release 15 DMRS for different communication devices.
